(19) United States
(12) Patent Application Publication
(10) Pub. No.: US 2013/0090469 A1
(43) Pub. Date: Apr. 11, 2013

(54) GREEN ZINC PORPHYRIN SENSITIZERS AND THEIR APPLICATIONS

(71) Applicants: Chen-Yu YEH, Taichung City (TW); Hsuan-Wei LEE, Pingtung City (TW); Tzyy-Weei OU, Taipei City (TW); Lun-Hong WANG, Taichung City (TW); Bo-Cheng GUO, Chiayi County (TW); Chi-Lun MAI, Pingtung City (TW); Jian-Ging CHEN, Pingtung County (TW)

(72) Inventors: Chen-Yu YEH, Taichung City (TW); Hsuan-Wei LEE, Pingtung City (TW); Tzyy-Weei OU, Taipei City (TW); Lun-Hong WANG, Taichung City (TW); Bo-Cheng GUO, Chiayi County (TW); Chi-Lun MAI, Pingtung City (TW); Jian-Ging CHEN, Pingtung County (TW)

(73) Assignees: NATIONAL CHUNG HSING UNIVERSITY, Taichung City (TW); JINTEX CORPORATION, LTD., Taipei City (TW)

(21) Appl. No.: 13/524,658

(22) Filed: Jun. 15, 2012

(30) Foreign Application Priority Data
Oct. 5, 2011 (TW) 100136163
Jan. 10, 2012 (TW) 101100963

(51) Int. Cl. C09B 47/00

(52) U.S. Cl. 540/145

(57) ABSTRACT

The present invention relates to zinc porphyrin-based photosensitive dyes, specifically to zinc porphyrin-based photosensitive dyes with green transparency. The photosensitive dyes exhibit high push-pull ability in the zinc porphyrin-based structure, higher absorption and power conversion efficiency. The photosensitive dyes are used in the manufacture of dye-sensitive solar cells.

### CROSS REFERENCE TO RELATED APPLICATION

This application claims the benefits of Taiwan Patent Application Number 100136163 filed on Oct. 5, 2011 and Taiwan Patent Application Number 101100963 filed on Jan. 10, 2012, the subject matters of which are incorporated herein by reference.

### BACKGROUND OF THE INVENTION

1. Field of the Invention

The present invention relates to zinc porphyrin-based photosensitive compounds exhibiting highly efficient push-pull ability between electrons, in particular, to green zinc porphyrin-based photosensitive compounds. Also, the present invention relates to photosensitive dyes with high absorption coefficient and photoelectric conversion efficiency made from said zinc porphyrin-based photosensitive compounds, which may be employed in solar cells.

2. Description of Related Art

Recently, the increased demands of sustainable and renewable energy resources have attracted much attention to the development of photovoltaic devices. While silicon-based solar cells require high-cost production processes, dye-sensitized solar cells (DSSC) are promising candidates for photovoltaic applications because of the low-cost of raw materials and fabrication. For example, the most efficient polypyridine ruthenium-based DSSC have achieved power conversion efficiency of more than 11%. However, the drawbacks, such as rarity, environmental concern, low absorbance at the near-IR region, etc., limit their applications in DSSC and have lead to burgeoning developments for organic dyes.

Generally, the advantages of organic dyes include, for example, high absorption coefficient, facile modification of molecular structures, easily tuned photophysical properties, etc. Many types of organic dyes, such as coumarines, triphenylamines, perylenes, porphyrins and phthalocyanines, have been investigated. Some organic sensitive dyes may exhibit remarkable conversion efficiency which is comparable to to those of ruthenium complexes in DSSC. All these highly efficient organic dyes have the same moleculars modified with a π-electron push-pull framework.

It is known that Japan Publication Number 2009-132657 published on Jun. 18, 2009 disclosed a porphyrin-based complex with photosensitizing action and a photoelectric transducer using the same, in which a substituent on the porphyrin complex may be present in a form of heterocycle or aromatic ring.

US Patent Publication Number 2010/0125136 A1, which was published on May 20, 2010 and claimed the priority of Taiwan Patent Application Number 97144426, disclosed zinc porphyrin-based photosensitizer dyes. The zinc porphyrin-based photosensitizer dyes have porphyrin rings with anchoring groups for attaching to the semiconductor surface. Those anchoring groups comprise carboxyl group or carboxylate anion, which may provide longer anchoring groups to facilitate electron transfer from the excited dye molecules to the semiconductor surface. Also, the porphyrin rings contain substituents having extended π-conjugated systems to increase the absorption of porphyrin rings within the visible region.

Further, the published reference, H. P. Lu et al. “Design and characterization of highly efficient porphyrin sensitizers for green see-through dye-sensitized solar cells”, Phys. Chem. Chem. Phys., 2009, 11, 10270-10274, refers to dye-sensitized complexes YD11-YD13 which are based on a structure of D-P-B-A wherein D represents an electron-donating diarylamino group, P represents a porphyrin light-harvesting center, B represents π-conjugation bridge and A represents a carboxyl anchoring group.

The published reference, C. W. Lee et al. “Novel Zinc Porphyrin Sensitizers for Dye-Sensitized Solar Cells: Synthesis and Spectral, Electrochemical, and Photovoltaic Properties”, Chem. Eur. J. 2009, 15, 1403-1412, refers to a synthesis of porphyrin-based sensitizer dyes having an electron-donating group (EDG) linked at the meso-position of porphyrin ring.

The published reference, Takeru Bessho et al. “Highly Efficient Mesoscopic Dye-Sensitized Solar Cells Based on Donor-Acceptor-Substituted Porphyrins”, Angew. Chem. Int. ed., 2010, 49, 6646-6649, refers to a porphyrin YD2 having electron-donor and electron-acceptor substituents. For example, attached to the porphyrin ring a diarylamino donor group acts as an electron donor (D), and a ethynylbenzoic acid acts as an electron acceptor (A), thereby constituting a porphyrin chromophore having D-π-A structure.

The published reference, S. L. Wu et al., “Design and Characterization of Porphyrin Sensitizers with a Push-pull Framework for Highly Efficient Dye-sensitized Solar Cells”, Energy Environ. Sci., 2010, 3, 949-955, refers to porphyrin sensitizers YD14-YD17 with push-pull framework and attaching diarylamino and/or triphenyl amino group to different meso-position.

The published reference, C. P. Hsueh et al. “Synthesis and characterization of porphyrin sensitizers with various electron-donating substituents for highly efficient dye-sensitized solar cells”, J. Mater. Chem., 2010, 20, 1127-1134, refers to porphyrin photosensitizer dyes YD1-YD8 for solar cells, attaching an electron-donating group (EDG) at meso-position.

The known dyes stated above easily cause an aggregation of molecules because of their poor solubility, and result in an insufficient injection of electrons into the conduction band (CB) of TiO₂ together with a loss of energy.

Also, according to recent advances on zinc porphyrin-based dyes with electron push-pull performance, it is known that the porphyrin ring attaching diarylamino as an electron-push group has a lower power conversion efficiency (η), for example, about 6.0%.

Thus, to resolve the technical problems and drawbacks as mentioned above, the inventors of the present invention design a series of highly efficient push-pull zinc porphyrin-based compounds and a synthesis of the same, to prevent a loss of energy due to the aggregation of molecules, as well as to provide a sufficient injection of electrons into a TiO₂ conductive band. Further, the inventors also develop a series of processes of preparation for the zinc porphyrin-based compounds that contain diarylamino groups as electron-donors, and have long alkoxyl chains replacing tert-butyl groups. In addition, to enhance the photoelectric conversion, the absorption range of UV-Vis spectrum is enlarged via a π-conjugated system.

### SUMMARY OF THE INVENTION

An objective of the present invention is to provide zinc porphyrin-based photosensitive compounds represented by a general formula as follows:

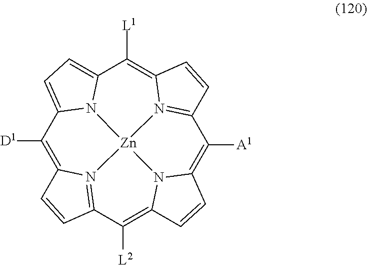

in the formula, L¹ and L² are each independently phenyl or —NR^{a}R^{b}, wherein the phenyl is optionally substituted with one to five substituents selected from the group consisting of C₁₋₁₂ alkyl, C₁₋₁₂ alkoxy and phenyl; R^{a} and R^{b} are each independently selected from the group consisting of C₁₋₁₂ alkyl, C₁₋₁₂ alkoxy and phenyl, where the phenyl is optionally substituted with one to five C₁₋₁₂ alkyl.

A¹ are selected from the group consisting of:

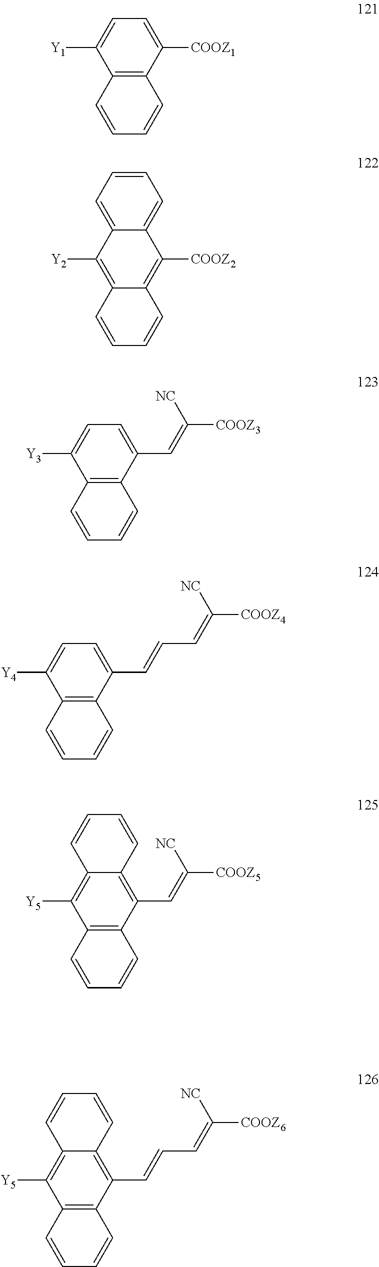

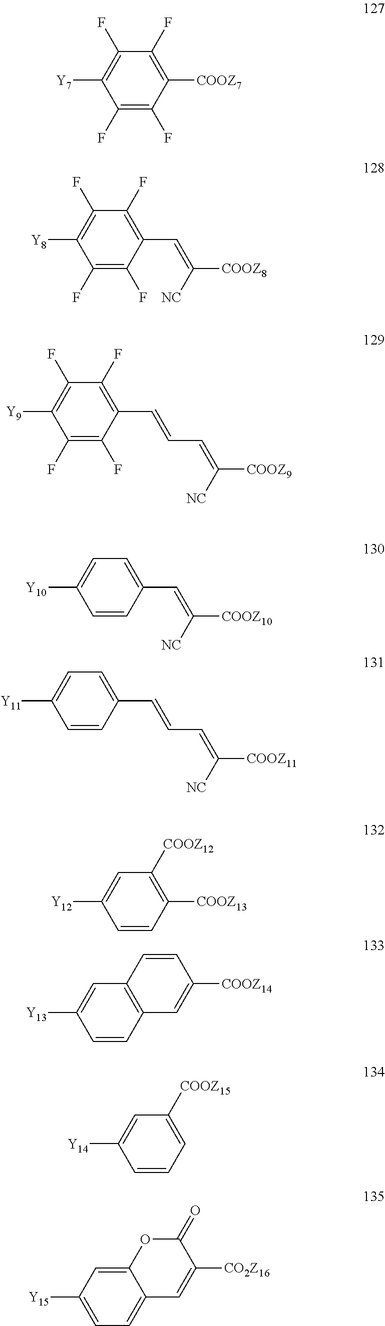

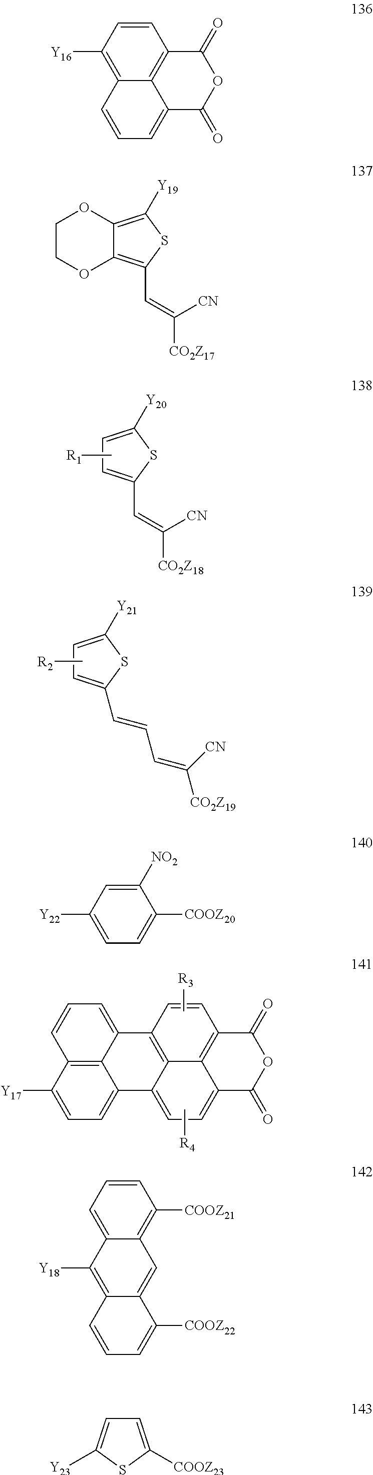

wherein R₁, R₂, R₃ and R₄ are each independently selected from the group consisting of C₁₋₁₂ alkyl, C₁₋₁₂ alkoxy, phenyl and phenoxy; Y₁˜Y₂₃ are each independently zero to one C₁₋₁₀ alkyl, one to five C₂₋₁₀ alkenyl or one to five C₂₋₁₀ alkynyl; Z₁˜Z₂₃ are each independently H, alkali metals or quaternary ammonium represented by the following general formula (200):

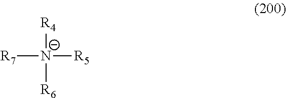

wherein R₄˜R₇ are each independently represented by CₘH₂ₘ₊₁ where m is an integer of 1 to 12.

D¹ is selected from the group consisting of:

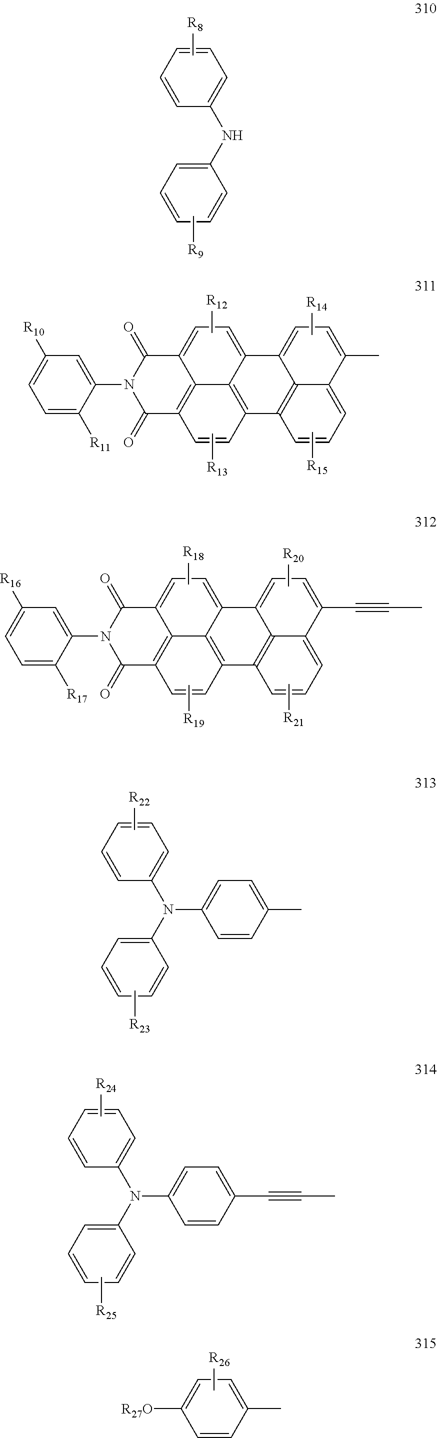

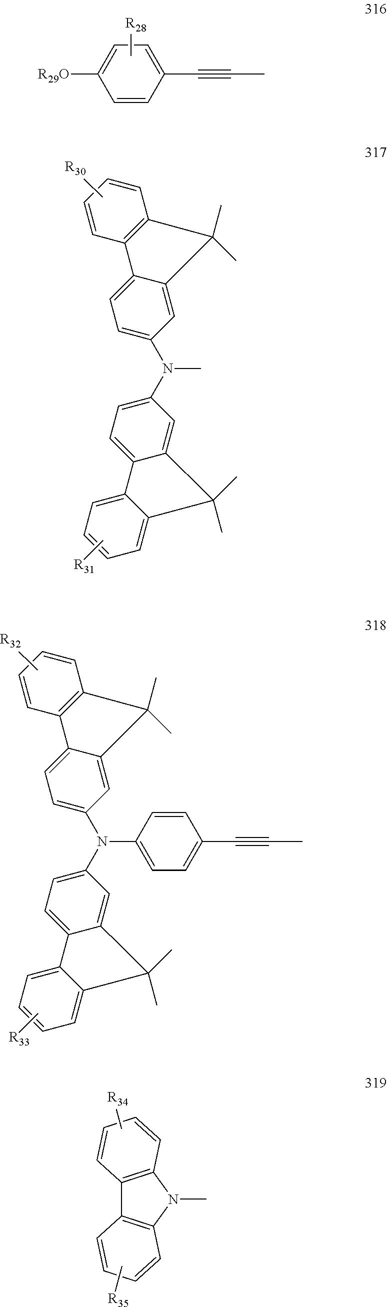

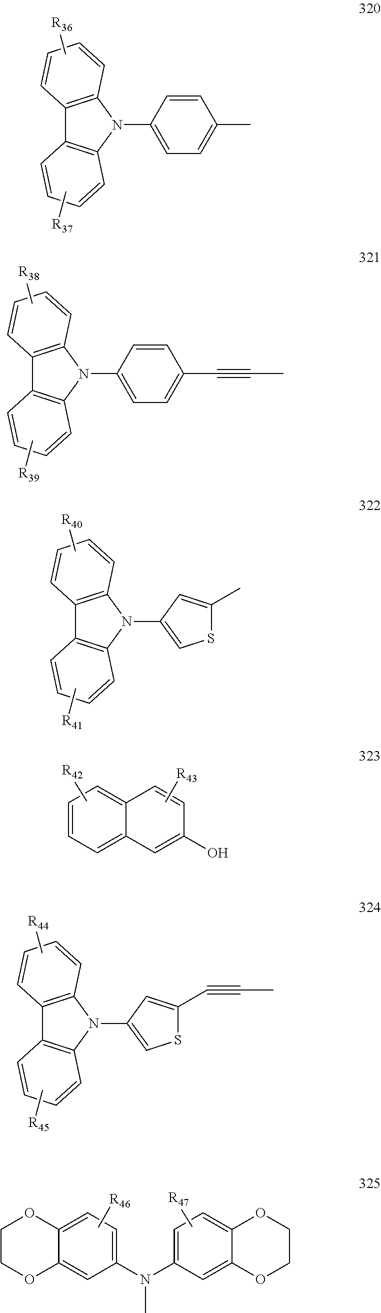

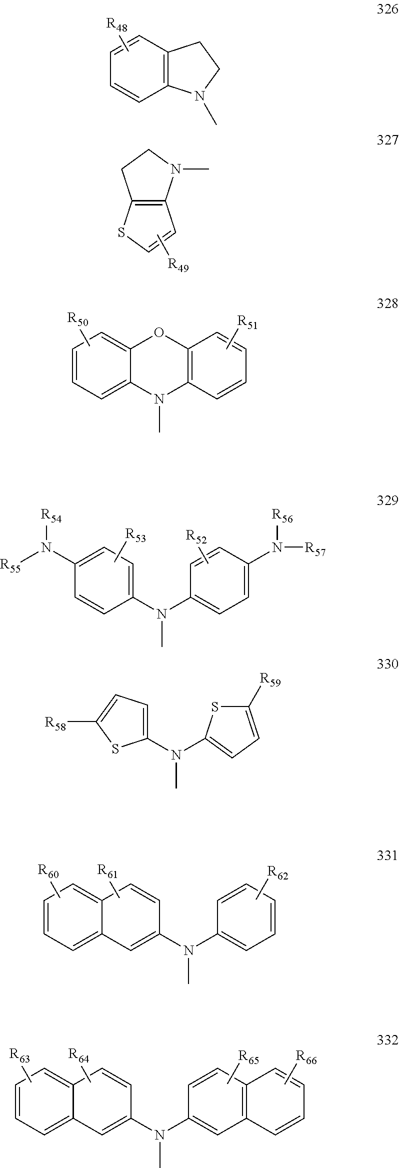

wherein R₈˜R₆₆ are each independently selected from the group consisting of H, phenyl, phenoxy, CₘH₂ₘ₊₁ where m is an integer of 1 to 12, OCₚH₂ₚ₊₁ where p is an integer of 1 to 12, CH₂(OC₂H₄)ₙOCH₃ where n is an integer of 1 to 30, and (OC₂H₄)_{q}OCH₃ where q is an integer of 1 to 30.

In the present invention, the zinc porphyrin-based photosensitive compounds bear a diaryl having a strong electron-push group at the meso-position of the porphyrin ring, and a hydrophobic long hydrocarbon chain modified from a tert-butyl on the diaryl group. Accordingly, the increase of stereo hindrance between molecules, the reduction of π-π interaction of the porphyrin ring itself and the enhancement of molecular solubility can be achieved, thereby preventing an aggregation of molecules.

Also, zinc porphyrin-based photosensitive dyes, in particular zinc porphyrin-based photosensitive dyes with green performance, contain the zinc porphyrin-based structure according to the present invention, in which the phenyl groups at the meso-10,20 positions of the porphyrin ring individually include two long alkoxy linked onto the para- or meta-site of phenyl to protect the dye from aggregation. On other side, the dyes exhibit highly efficient push-pull ability between electrons. Thus, the injection of electrons into one surface of the TiO₂ anode may be efficiently increased, and the reduction of charge recombination and enhancement of photovoltaic property for the dyes can be achieved.

In the present invention, a triple bond-containing group as a crosslinking group may be linked onto the meso-position of the porphyrin ring. Further, a naphthalene or a anthracene obtained from the modification of benzoic acid may extend the length of the conjugated system in the porphyrin ring and form together with a carboxy group a push-pull system in the whole structure. Accordingly, the absorbance may be shifted to IR region and can obtain a superior effect of charge separation, thereby injecting excited electrons into conductive band (CB) on TiO₂ surface through those groups and achieving an increase of photoelectric conversion efficiency.

According to the present invention, the thus-modified zinc porphyrin-based photosensitive compounds, in particular green zinc porphyrin-based photosensitive compounds, may be used as raw materials of photosensitized dye and are suitably employed in the applications of photoelectric conversion cells, such as dye-sensitized solar cells and the like.

Further an objective of the present invention is to provide photosensitized dyes having high absorption coefficient and photoelectric conversion efficiency, in particular a photosensitive dye for solar cells.

A further objective of the present invention is to provide uses of the zinc porphyrin-based photosensitive dyes in solar cells.

These features and advantages of the present invention will be further described and more readily apparent from a review of the detailed description of the preferred embodiments hereinafter.

### BRIEF DESCRIPTION OF THE DRAWINGS

The following detailed description of the preferred embodiments of the present invention can best be understood when read in connection with the drawings as follows:

FIG. 1 illustrates the photoelectric conversion efficiencies of porphyrin dyes 9, 23 and 47 according to the present invention.

FIG. 2 illustrates the UV-Vis absorbance spectra of porphyrin dyes 9, 16 and 23 according to the present invention.

### DETAILED DESCRIPTION OF THE INVENTION

In one embodiment of the present invention, the zinc porphyrin-based photosensitive compounds are represented by the following formula (120):

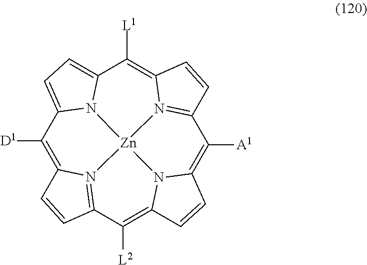

wherein L¹ and L² are each independently a phenyl having two to five substituents selected from the group consisting of C₁₋₁₂ alkyl and C₁₋₁₂ alkoxy. Preferably, L¹ and L² are each independently a phenyl having two to three substituents selected from the group consisting of C₁₋₁₂ alkyl and C₁₋₁₂ alkoxy. More preferably, L¹ and L² are each independently a phenyl having two to three substituents selected from the group consisting of C₁₋₁₂ alkoxy. Most preferably, L¹ and L² are each independently a phenyl substituted with two C₅₋₁₂ alkoxy.

In another embodiment of the present invention, L¹ and L² are each independently —NR^{a}R^{b}, wherein R^{a} and R^{b} are each independently C₁₋₁₂ alkyl, C₁₋₁₂ alkoxy or substituted phenyl. Preferably, the substituted phenyl has one to five substituents selected from the group consisting of C₁₋₁₂ alkyl and C₁₋₁₂ alkoxy; more preferably two to three substituents selected form the group consisting of C₁₋₁₂ alkyl and C₁₋₁₂ alkoxy.

In the present invention, R^{a} and R^{b} may be identical.

According to the present invention, the phenyl may be substituted with substituent(s) on the meta-, ortho- or para-position of phenyl ring; and preferably the meta- or ortho-position.

Also, in the formula (120) of zinc porphyrin-based photosensitive compounds according to the present invention, L¹ and L² linked on the meso-position of porphyrin ring may be identical, to form a porphyrin with a symmetrical configuration.

A¹ may be selected from the group consisting of:

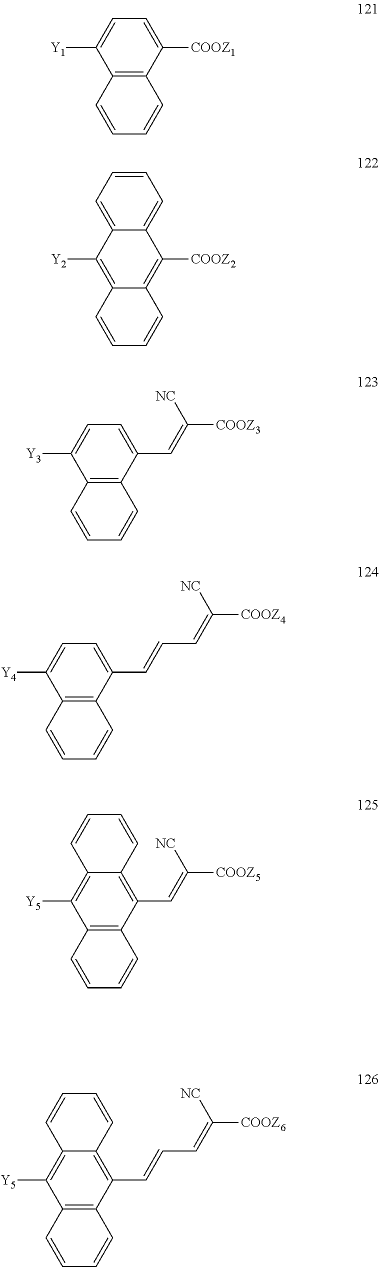

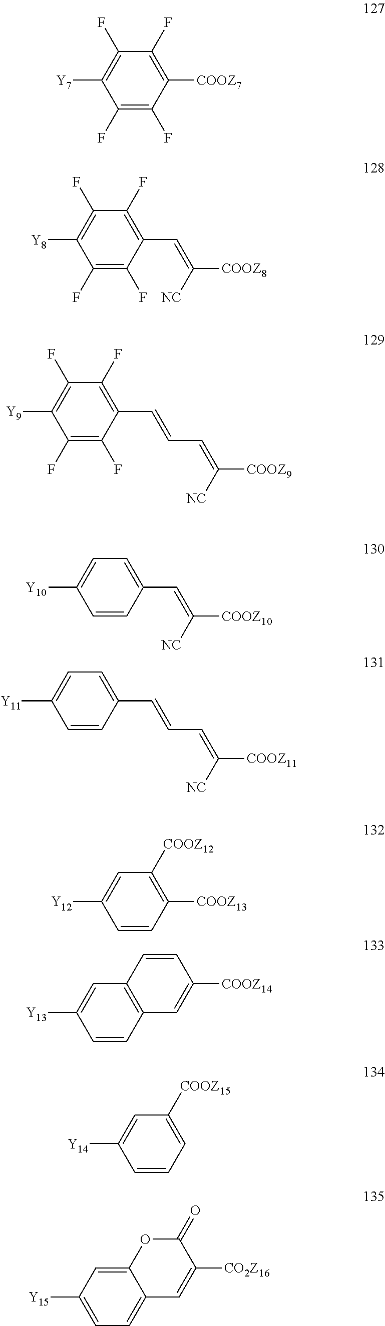

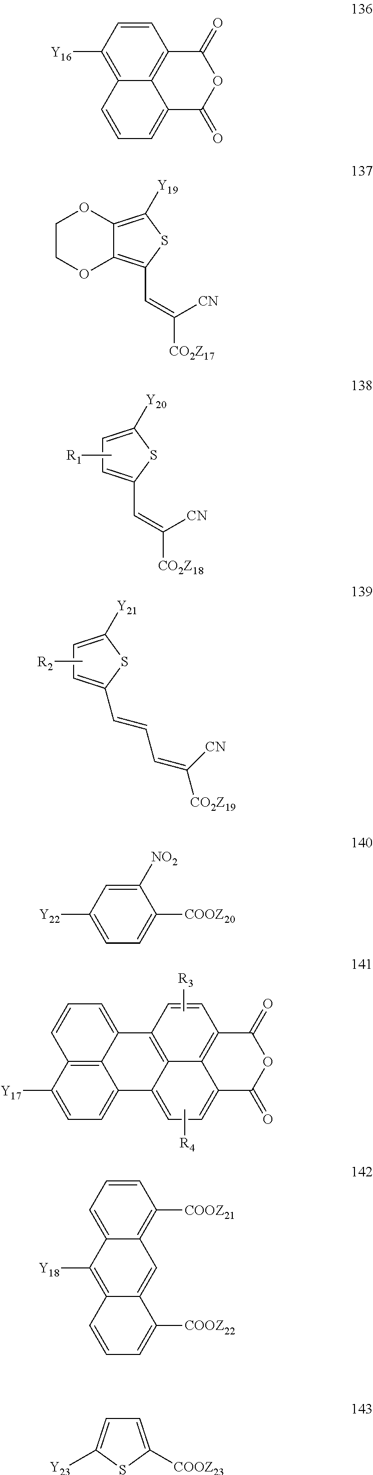

wherein R₁, R₂, R₃ and R₄ are each independently selected from the group consisting of H, C₁₋₁₂ alkyl, C₁₋₁₂ alkoxy, phenyl and phenoxy; Y₁˜Y₂₃ are each independently selected from the group consisting of 0 to one C₁₋₁₀ alkyl, one to five C₂₋₁₀ alkenyl and one to five C₂₋₁₀ alkynyl; Z₁˜Z₂₃ are each independently selected from the group consisting of H, alkali metals and quaternary ammonium.

In an embodiment of the present invention, R₁, R₂, and R₃ are each independently selected from the group consisting of C₁₋₁₂ alkyl, C₂₋₁₀ monoalkenyl, C₂₋₁₀ dialkenyl, phenyl, C₁₋₆ alkyl-substituted phenyl, C₁₋₆ monoalkenyl-substituted phenyl, C₁₋₆ dialkenyl-substituted phenyl, C₂₋₆ alkynyl-substituted phenyl, naphthyl, anthranyl and thienyl, wherein the C₂₋₁₀ monoalkenyl is optionally substituted with cyano, phenyl or naphthyl, and the phenyl or C₁₋₆ alkyl-substituted phenyl is optionally substituted with —NO₂ or halogen.

In the present invention, the quaternary ammonium is represented by a general formula (200) as follows:

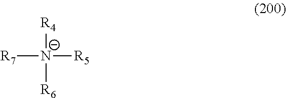

wherein R₄˜R₇ are each independently represented by a general formula of CₘH₂ₘ₊₁ where m is an integer of 1 to 12.

D¹ may be selected from the group consisting of:

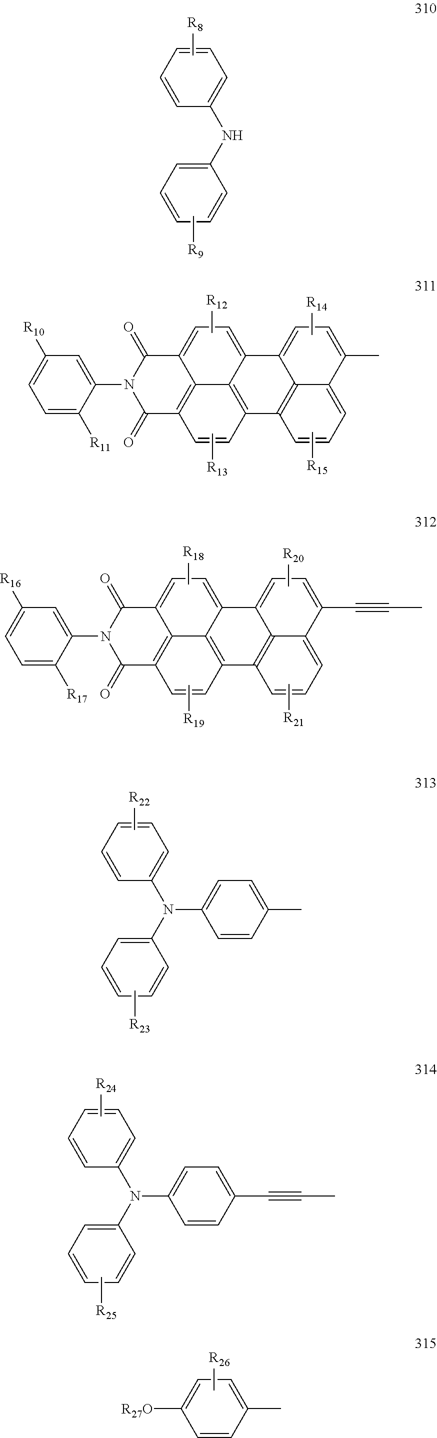

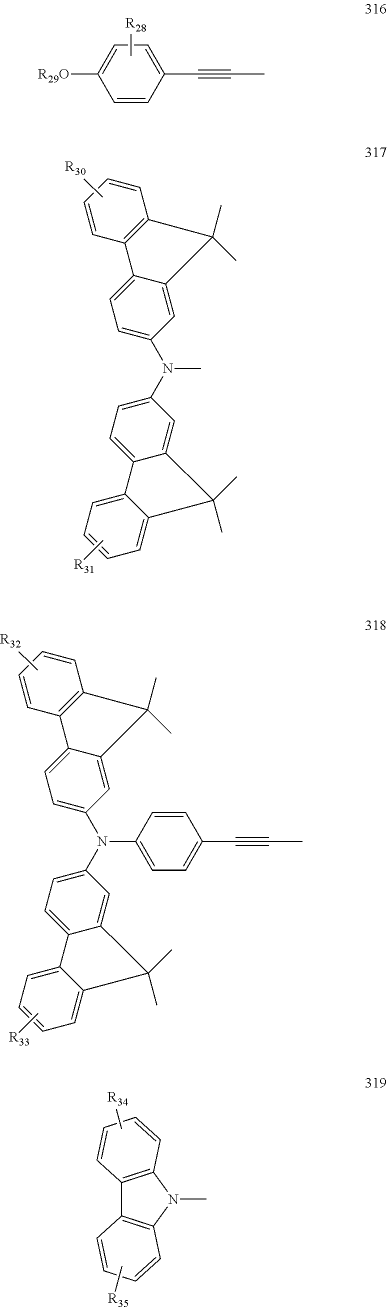

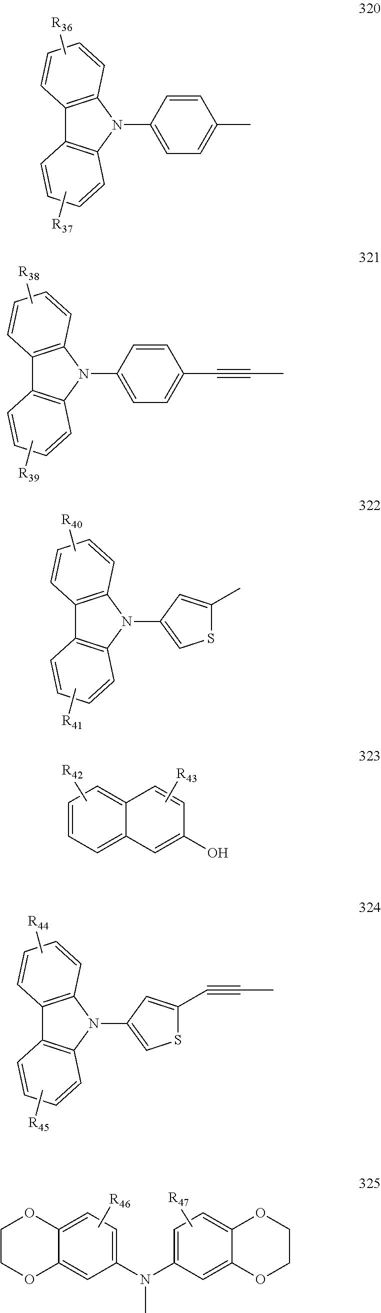

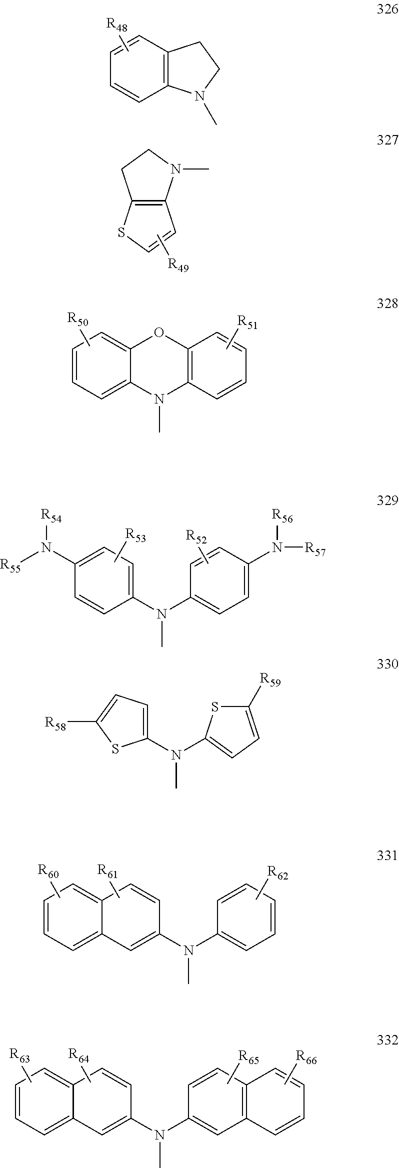

wherein R₈˜R₆₆ are each independently selected from the group consisting of H, phenyl, phenoxy, CₘH₂ₘ₊₁ where m is an integer of 1 to 12, OCₚH₂ₚ₊₁ where p is an integer of 1 to 12, CH₂(OC₂H₄)ₚOCH₃ where n is an integer of 1 to 30, and (OC₂H₄)_{q}OCH₃ where q is an integer of 1 to 30.

According to a preferred embodiment of the present invention, L¹ and L² each independently represent a phenyl having two substituents selected from the group consisting of C₁₋₁₂ alkyl and C₁₋₁₂ alkoxy; D¹ is —NR^{a}R^{b}, wherein R^{a} and R^{b} represent identical groups selected from the group consisting of C₁₋₁₂ alkyl and C₁₋₁₂ alkoxy; and A¹ represents a functional group having C₂₋₆ alkynyl in which the functional group is a phenyl optionally substituted with substituent(s) selected from the group consisting of carboxy, C₂₋₆ alkenyl substituted with cyano, NO₂, C₂₋₅ alkynyl,

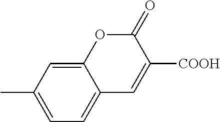

or fluoro.

In the present invention, the exemplary compounds of the zinc porphyrin-based photosensitized dyes are listed below:

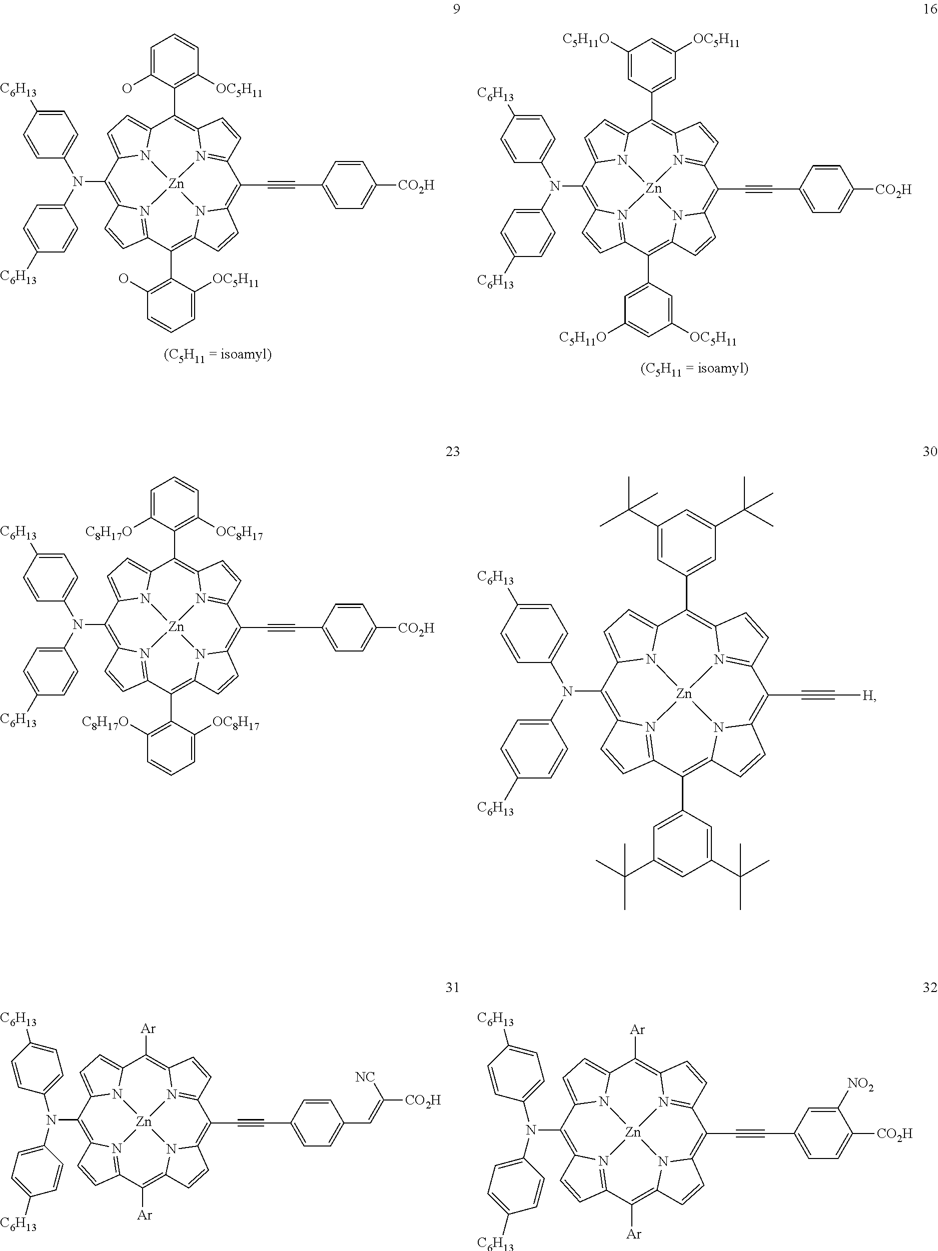

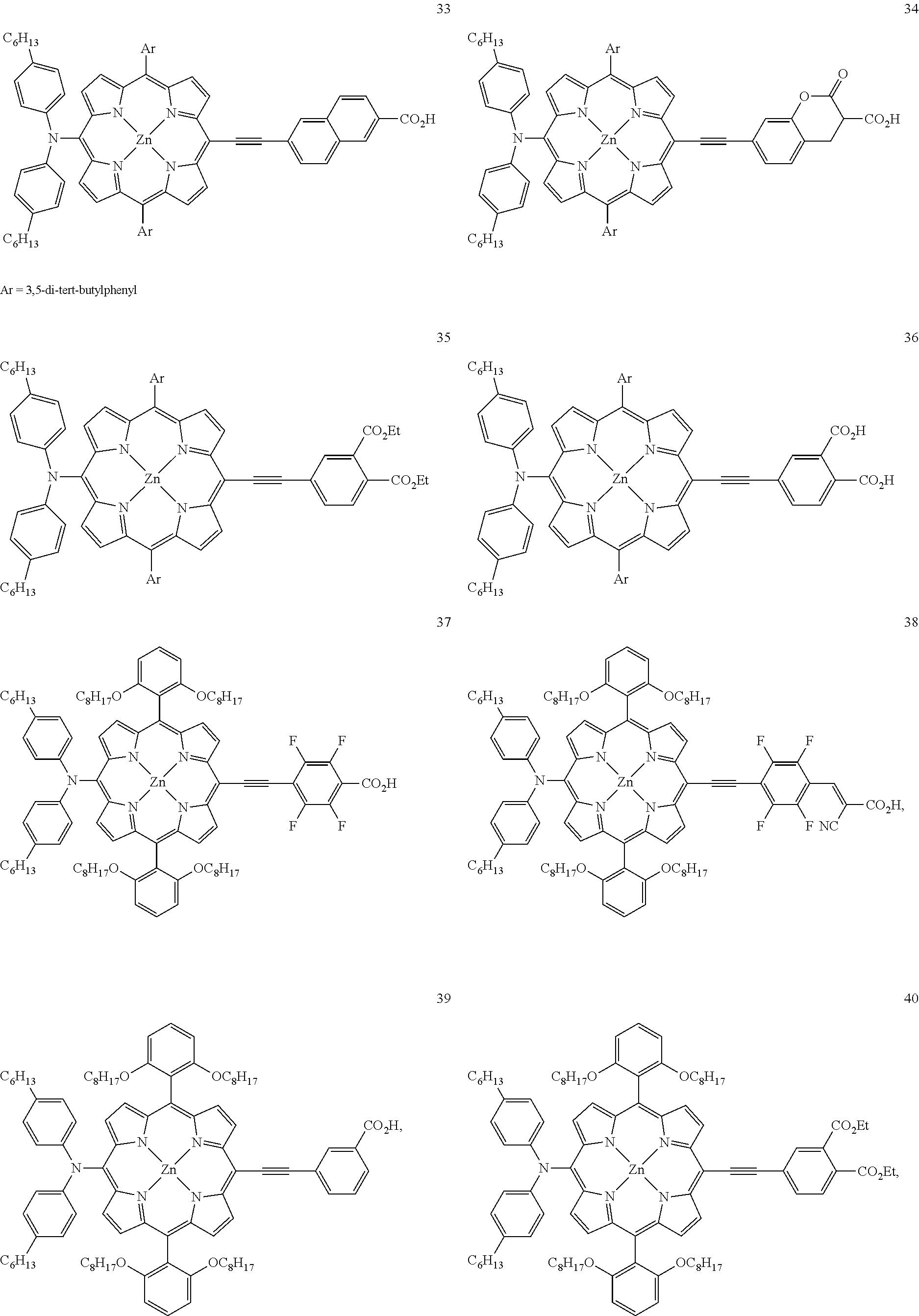

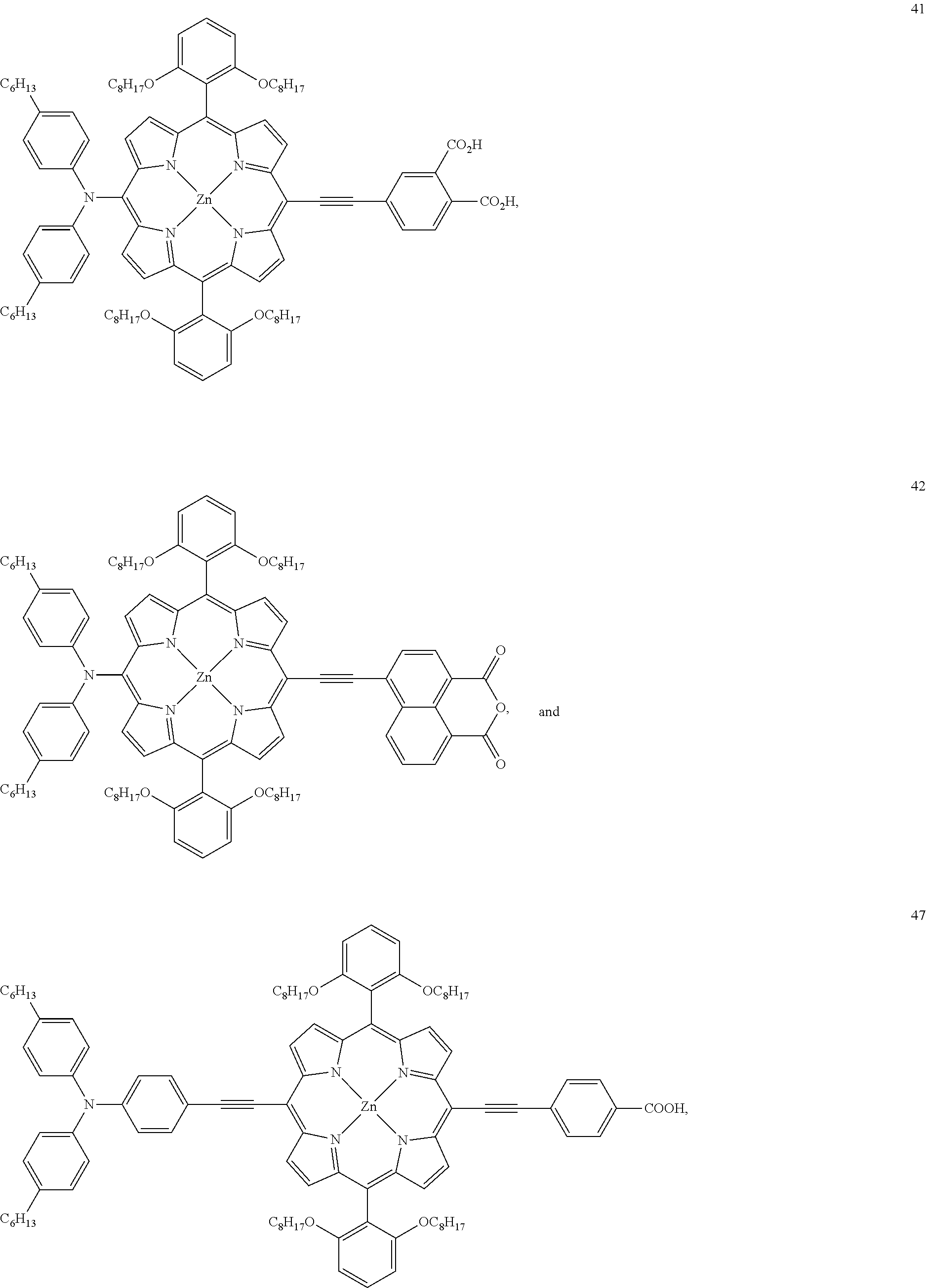

Hereinafter, reference will now be made in detail to preferred embodiments of the present invention, which constitute the best modes of practicing the present invention. However, it is to be understood that the disclosed embodiments are merely exemplary of the present invention that may be embodied in various and alternative forms, but are not intended to limit the scope of the present invention.

### SYNTHESIS EXAMPLES

### Example 1

### Synthesis of Porphyrin Compound 9

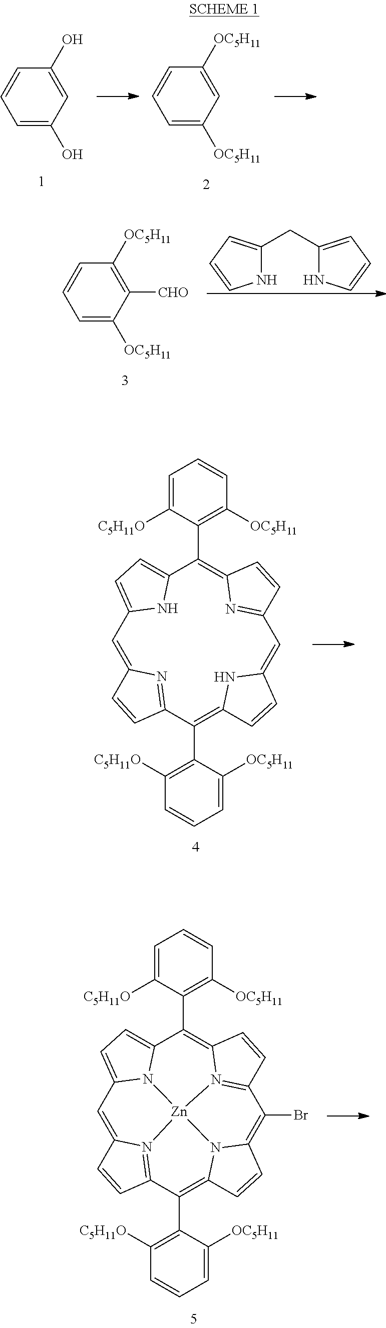

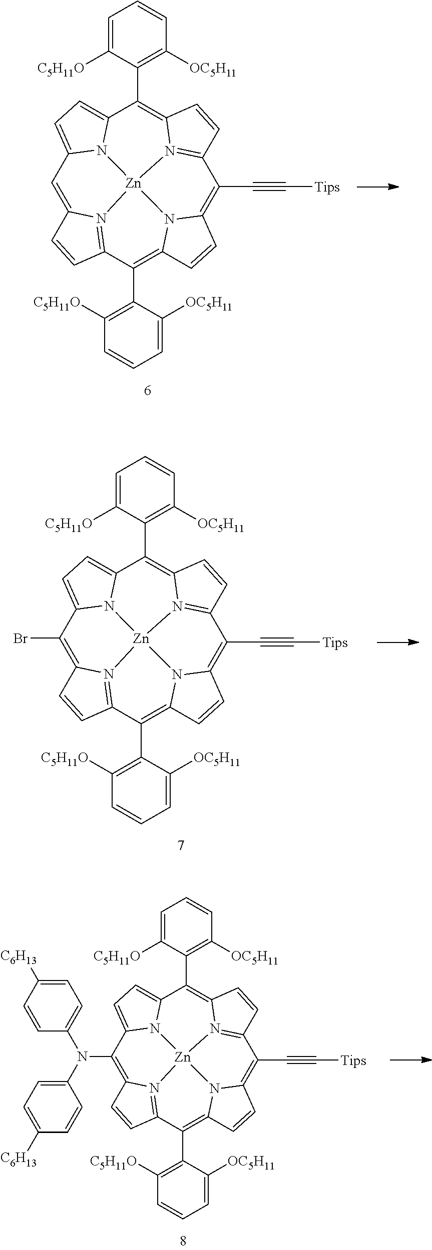

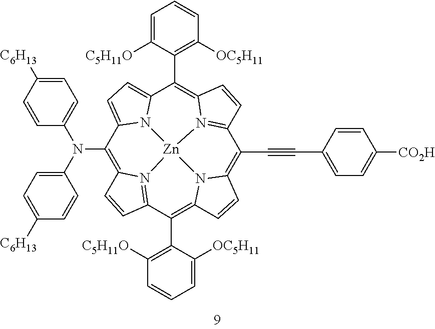

### i) 1,3-Dipentyloxy benzene, Compound 2

To a solution of resorcinol (60.0 g, 0.5 mol) dissolved in acetone (2500 mL) was added K₂CO₃ (24.5 g, 2.5 mol). The solution was heated and stirred under nitrogen atmosphere for 20 minutes; and then 1-bromo-3-methyl butane (251.7 mL, 2.0 mol) was introduced, to obtain a mixture. After the mixture was refluxed for six days, the mixture was filtered; and then the solvent was removed under concentration. The residue was extracted with dichloromethane; and the extracts in the organic layer were combined and dried over anhydrous MgSO₄. The resulting crude product was purified by Silica Gel Column Chromatography using n-hexane, to give Compound 2 as a white liquid (113.75 g, 91%).

The white liquid was identified and assayed, and the result was shown as follows: ¹H NMR (CdCl₃, 400 MHz) δ_{H}=7.16 (t, J=8.0 Hz, 1H), 6.53-6.43 (m, 3H), 3.97 (t, J=6.8 Hz, 4H), 1.90-1.77 (m, 2H), 1.72-1.62 (m, 4H), 1.00-0.92 (m, 12H).

### ii) 2,6-Bis(3-methylbutoxy)benzenaldehyde, Compound 3

A three-necked flask was equipped with an addition funnel and charged with a solution of Compound 2 (25 g, 0.1 mol) and tetramethyl ethylene diamine TMEDA (0.125 mol) in tetrahydrofuran THF. The solution was degassed with nitrogen gas for 15 minutes; cooled to 0° C.; and then n-butyl lithium (93.7 mL, 1.6M in n-hexane) was added dropwise over 20 minutes. After stirring the solution for 3 hours, the solution was warmed to room temperature. To the solution was added dropwise dimethyl methanamine DMF (0.25 mol); and allowed to stir and react for an additional 2 hours. The reaction was quenched with water; and the mixture obtained therefrom was extracted with ether. The extracts were combined and dried over anhydrous MgSO₄; and the solvent was removed under reduced pressure. The resulting crude product was recrystallized from hexane, to yield Compound 3 as a white solid (22.8 g, 82%).

The white solid was identified and assayed, and the result was shown as follows: ¹H NMR (CdCl₃, 400 MHz): δ_{H}=10.52 (s, 1H), 7.38 (t, J=8.4 Hz, 1H), 6.54 (d, J=8.8 Hz, 2H), 4.06 (t, J=6.4 Hz, 4H), 1.90-1.80 (m, 2H), 1.80-1.60 (m, 4H), 1.20-0.80 (m, 12H); ¹³C NMR (CdCl₃, 100 MHz): δ_{C}=189.3, 161.7, 135.5, 104.5, 67.3, 37.7, 25.0, 22.5. MALDI-TOF: m/z calcd for C₁₇H₂₆O₃ 278. found 279 [M+1]⁺.

### iii) 5,15-Bis(2,6-bis(3-methylbutoxy)phenyl)porphyrin, Compound 4

To a degassed solution of dipyrromethane (41.0 mmol) and Compound 3 (41.0 mmol) in dichloromethane DCM (5.4 L) was added trifluoroacetic acid (37.3 mmol); and the solution was stirred at 23° C. for 4 hours. To the solution was added 2,3-dichloro-5,6-dicyano-1,4-benzoquinone DDQ (14.1 g, 62.1 mmol) to form a mixture; and the mixture was stirred for an additional 1 hour and then filtered through silica SiO₂. The solvent was removed from the residue under reduced pressure. The residue was purified by Silica Gel Column Chromatography using dichloromethane DCM/n-hexane (1:2), to obtain a crude product. The crude product was then recrystallized from MeOH/CH₂Cl₂, to yield Compound 4 as a purple powder (5.31 g, 32%).

The purple powder was identified and assayed, and the result was shown as follows: ¹H NMR (CdCl₃, 400 MHz): δ_{H}=10.16 (s, 2H), 9.27 (d, J=4.4 Hz, 4H), 8.98 (d, J=4.4 Hz, 4H), 7.72 (t, J=8.4 Hz, 2H), 7.03 (d, J=8.4 Hz, 4H), 3.87 (t, J=6.4 Hz, 8H), 0.87-0.64 (m, 12H), 0.25 (d, J=6.8 Hz, 24H), −3.03 (s, 2H); ¹³C NMR (CdCl₃, 100 MHz): δ_{C}=160.2, 147.7, 145.0, 130.7, 130.5, 130.0, 119.9, 111.6, 105.3, 103.9, 67.1, 37.3, 24.2, 22.0. MALDI-TOF: m/z calcd for C₅₂H₆₂N₄O₄ 806. found 806 [M]⁺.

### iv) (5-Bromo-10,20-bis(2,6-bis(3-methylbutoxy)phenyl)porphyrinato)zinc(II), Compound 5

To a stirred solution of Compound 4 (1.24 mmol) in DCM (400 mL) was added slowly a solution of N-bromosuccinimide NBS (1.12 mmol) in DCM (50 mL) at 0° C. under nitrogen atmosphere over 6 hours. Subsequently, the solvents were removed under reduced pressure to obtain a residue. The residue was purified by Silica Gel Column Chromatography using DCM/n-hexane (1:2) to obtain a crude product. The crude product was recrystallized from MeOH/CH₂Cl₂, to yield an intermediate product 5-bromo-10,20-bis(2,6-bis(3-methylbutoxy)phenyl)porphyrin as a purple powder (0.61 g, 56%).

The intermediate product was identified and assayed, and the result was shown as follows: ¹H NMR (CdCl₃, 400 MHz): δ_{H}=10.03 (s, 1H), 9.63 (d, J=4.8 Hz, 2H), 9.18 (d, J=4.4 Hz, 2H), 8.92-8.84 (m, 4H), 7.72 (t, J=8.4 Hz, 2H), 7.02 (d, J=8.0 Hz, 4H), 3.88 (t, J=6.4 Hz, 8H), 0.85 (dd, J=6.8 Hz, J=13.6 Hz, 8H), 0.82-0.71 (m, 4H), 0.26 (d, J=6.4 Hz, 24H), −2.87 (s, 2H); ¹³C NMR (CdCl₃, 100 MHz): δ_{C}=160.1, 131.7, 131.2, 130.8, 130.3, 130.1, 119.9, 112.9, 105.1, 104.2, 102.0, 67.1, 37.2, 24.2, 22.0. MALDI-TOF: m/z calcd for C₅₂H₆₁BrN₄O₄ 886. found 886 [M]⁺.

A suspension of the thus-prepared intermediate product 5-bromo-10,20-bis(2,6-bis(3-methylbutoxy)phenyl)porphyrin (1.0 g, 1.13 mmol) and Zn(OAc)₂.2H₂O (2.5 g, 11.3 mmol) in a solvent mixture of dichloromethane and methanol was stirred and reacted at room temperature for 3 hours. The reaction was quenched with water; and the resulting mixture was extracted with dichloromethane. The extracts were combined; and the combined extracts were washed with water and dried over anhydrous MgSO₄. After removing the solvents under reduced pressure, Compound 5 was recovered (1.03 g, 96%).

Compound 5 was identified and assayed, and the result was shown as follows: ¹H NMR (CdCl₃, 400 MHz): δ_{H}=10.09 (s, 1H), 9.71 (d, J=4.8 Hz, 2H), 9.26 (d, J=4.8 Hz, 2H), 9.04-8.90 (m, 4H), 7.72 (t, J=8.0 Hz, 2H), 7.02 (d, J=8.4 Hz, 4H), 3.87 (t, J=6.4 Hz, 8H), 0.93-0.75 (m, 8H), 0.75-0.60 (m, 4H), 0.30-0.10 (m, 24H); ¹³C NMR (CdCl₃, 100 MHz): δ_{C}=160.0, 150.9, 150.8, 149.9, 148.8, 132.2, 132.1, 132.0, 131.5, 129.8, 121.1, 113.2, 105.2, 103.3, 67.1, 37.2, 24.1, 21.9. MALDI-TOF: m/z: calcd for C₅₂H₅₉BrN₄O₄Zn 948. found 948 [M]⁺.

### v) (5-(Triisopropylsilyl)ethynyl-10,20-bis(2,6-bis(3-methylbutoxy)phenyl)porphyrinato) Zinc(II), Compound 6

A mixture of Compound 5 (1.0 g, 1.05 mmol), triisopropylacetylene (0.28 mL, 1.26 mmol), bis(triphenylphosphine)palladium(II) dichloride Pd(PPh₃)₂Cl₂ (74.0 mg, 1.26 mmol), CuI(I) (20.1 mg, 0.11 mmol), tetrahydrofuran (32.8 mL) and triethylamine NEt₃ (6.5 mL) was gently refluxed and reacted under nitrogen atmosphere for 4 hours. Then, the solvents were removed under vacuum to obtain a residue. The residue was purified by Silica Gel Column Chromatography using dichloromethane/n-hexane (1:2), to yield Compound 6 as a purple solid (1.01 g, 92%).

The purple solid was identified and assayed, and the result was shown as follows: ¹H NMR (CdCl₃, 400 MHz): δ_{H}=10.03 (s, 1H), 9.72 (d, J=4.4 Hz, 2H), 9.21 (d, J=4.4 Hz, 2H), 8.94 (d, J=4.4 Hz, 2H), 8.92 (d, J=4.4 Hz, 2H), 7.69 (t, J=8.8 Hz, 2H), 7.00 (d, J=8.8 Hz, 4H), 3.86 (t, J=6.4 Hz, 8H), 1.56-1.34 (m, 21H), 0.84-0.66 (m, 12H), 0.24 (d, J=6.4 Hz, 24H); ¹³C NMR (CdCl₃, 100 MHz): δ_{C}=160.1, 151.9, 150.8, 150.2, 148.8, 131.7, 131.2, 131.0, 129.5, 121.3, 113.2, 105.9, 105.0, 67.0, 37.3, 24.3, 22.0, 19.1, 12.0. MALDI-TOF: m/z calcd for C₆₃H₈₀N₄O₄SiZn 1050. found 1050 [M]⁺.

### vi) (5-Bromo-15-(triisopropylsilyl)ethynyl-10,20-bis(2,6-bis(3-methylbutoxy)phenyl)porphyrinato)Zinc(II), Compound 7

To a stirred solution of Compound 6 (0.48 mmol) in DCM (265 mL) and pyridine (26.5 mL) was added NBS (0.71 mmol) at 23° C.; and stirred for 0.5 hour. The solvent was removed under reduced pressure to obtain a residue. The residue was purified by Silica Gel Column Chromatography using dichloromethane/n-hexane (1:2), to yield Compound 7 (0.51 g, 93%).

Compound 7 was identified and assayed, and the result was shown as follows: ¹H NMR (CdCl₃, 400 MHz): δ_{H}=9.63 (d, J=4.4 Hz, 2H), 9.57 (d, J=4.4 Hz, 2H), 8.84 (d, J=4.4 Hz, 2H), 8.82 (d, J=4.8 Hz, 2H), 7.68 (t, J=8.4 Hz, 2H), 6.99 (d, J=8.4 Hz, 4H), 3.87 (t, J=6.4 Hz, 8H), 1.47-1.35 (m, 21H), 0.92-0.70 (m, 12H), 0.50-0.14 (m, 24H); ¹³C NMR (CdCl₃, 100 MHz): δ_{C}=160.0, 152.8, 151.3, 150.6, 148.7, 143.7, 132.2, 131.9, 130.7, 129.7, 121.9, 120.9, 114.6, 104.9, 98.7, 96.0, 67.0, 39.3, 24.2, 22.0, 19.1, 11.9. MALDI-TOF: m/z calcd for C₆₃H₇₉BrN₄O₄SiZn 1128. found 1128 [M]⁺.

### vii) (5-Bis(4-hexylphenyl)amino-15-(triisopropylsilyl)ethynyl-10,20-bis(2,6-bis(3-methyl butoxy)phenyl)porphyrinato)Zinc(II), Compound 8

A mixture of bis(4-hexylphenyl)amine (0.598 mg, 1.77 mmol) and 60% NaH (70.9 g, 1.77 mmol), Compound 7 (0.5 g, 0.44 mmol), bis(2-diphenylphosphino)phenyl ether DPEphos (95.4 mg, 0.177 mmol) and palladium acetate(II) Pd(OAc)₂ (27.1 mg, 0.11 mmol) in dry tetrahydrofuran was gently refluxed and reacted under nitrogen atmosphere for 4 hours. The solvent was removed under vacuum to obtain a residue. The residue was purified by Silica Gel Column Chromatography using dichloromethane/n-hexane (1:2), to yield Compound 8 (0.31 g, 51%).

Compound 8 was identified and assayed, and the result was shown as follows: ¹H NMR (CdCl₃, 400 MHz): δ_{H}=9.71 (d, J=4.8 Hz, 2H), 9.21 (d, J=4.8 Hz, 2H), 8.91 (d, J=4.4 Hz, 2H), 8.72 (d, J=4.8 Hz, 2H), 7.68 (t, J=8.4 Hz, 2H), 7.25 (t, J=7.2 Hz, 4H), 7.10-6.90 (m, 8H), 3.97-3.82 (m, 8H), 2.49 (t, J=7.2 Hz, 4H), 1.51-1.40 (m, 21H), 1.40-1.21 (m, 16H), 0.97-0.81 (m, 14H), 0.72-0.57 (m, 4H), 0.35-0.14 (m, 24H); ¹³C NMR (CdCl₃, 100 MHz): δ_{C}=159.9, 152.4, 152.0, 150.5, 150.2, 134.6, 132.0, 130.5, 130.4, 129.8, 128.7, 122.9, 121.9, 120.7, 114.2, 110.1, 105.1, 99.1, 96.4, 67.0, 37.3, 35.2, 31.7, 31.6, 29.1, 24.0, 22.6, 22.0, 19.1, 14.1, 11.9. MALDI-TOF: m/z calcd for C₈₇H₁₁₃N₅O₄SiZn 1385. found 1385 [M]⁺.

### viii) (5,15-Bis(2,6-bis(3-methylbutoxy)phenyl)-10-(bis(4-hexylphenyl)amino)-20-(4-carboxyphenylethynyl)porphyrinato)Zinc(II), Compound 9

To a solution of Compound 8 (0.072 mmol) in dry tetrahydrofuran (10 mL) was added tetrabutylammonium fluoride TBAF (0.72 mL, 1M in THF); and stirred and reacted at 23° C. under nitrogen atmosphere for 30 minutes. The reaction was quenched with water; and the resulting solution was extracted with dichloromethane. The extracts in the organic layer were combined and dried over anhydrous MgSO₄. The solvent was removed under reduced pressure to obtain a residue. A mixture of the residue and 4-iodobenzoic acid (0.29 mmol) was dissolved in a solvent mixture of dry tetrahydrofuran (35.5 mL) and NEt₃ (7.1 mL); and then was degassed with nitrogen gas for 10 minutes, to obtain a degassed solution. To the degassed solution was added tris(dibenzylideneacetone)dipalladium(0) Pd₂(dba)₃ (0.014 mmol) and triphenyl arsine AsPh₃ (0.14 mmol); and subsequently was refluxed and reacted under nitrogen atmosphere for 4 hours. The solvent was removed under reduced pressure to obtain a residue. The residue was purified by Silica Gel Column Chromatography using dichloromethane/methanol (20:1); and then recrystallized from n-hexane/ethanol, to yield Compound 9 as a green solid (79.8 g, 82%).

Compound 9 was identified and assayed, and the result was shown as follows: ¹H NMR (CdCl₃, 400 MHz): δ_{H}=9.68 (d, J=4.8 Hz, 2H), 9.17 (d, J=4.4 Hz, 2H), 8.92 (d, J=4.4 Hz, 2H), 8.68 (d, J=4.8 Hz, 2H), 8.17 (d, J=7.2 Hz, 2H), 8.08 (d, J=8.0 Hz, 2H), 7.68 (t, J=8.8 Hz, 2H), 7.21 (d, J=8.4 Hz, 4H), 6.99 (d, J=8.4 Hz, 4H), 6.95 (d, J=8.8 Hz, 4H), 3.98-3.90 (m, 8H), 2.45 (t, J=15.6 Hz, 4H), 1.40-1.18 (m, 16H), 0.97-0.79 (m, 12H), 0.76-0.60 (m, 6H), 0.38-0.14 (m, 24H); ¹³C NMR (CdCl₃, 100 MHz): δ_{C}=170.0, 159.8, 152.0, 151.9, 150.6, 150.4, 150.2, 134.5, 132.1, 131.8, 131.1, 130.4, 130.3, 130.0, 129.8, 128.7, 128.1, 123.3, 121.9, 121.1, 114.0, 105.3, 97.6, 97.3, 94.6, 67.1, 37.3, 35.2, 31.7, 31.5, 29.1, 24.0, 22.6, 22.0, 14.1; ESI-MS: m/z calcd for C₈₅H₉₇N₅O₆Zn 1349. found 1349 [M]⁺.

### Example 2

### Synthesis of Porphyrin Compound 16

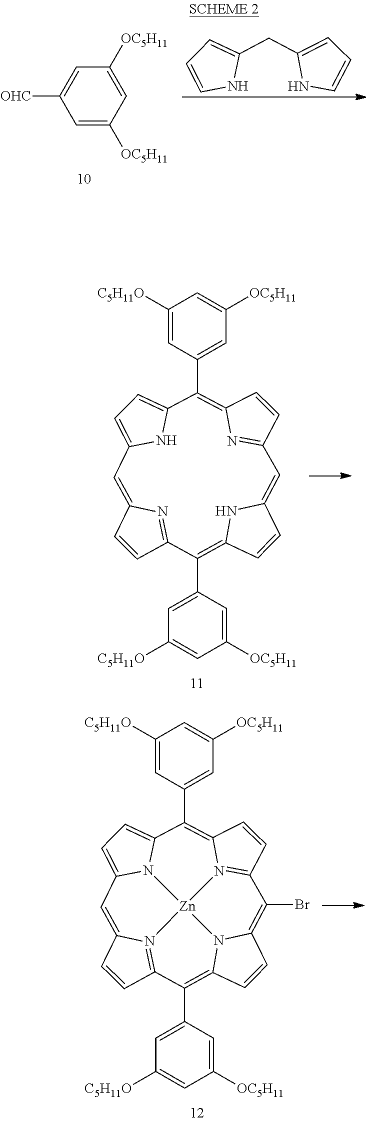

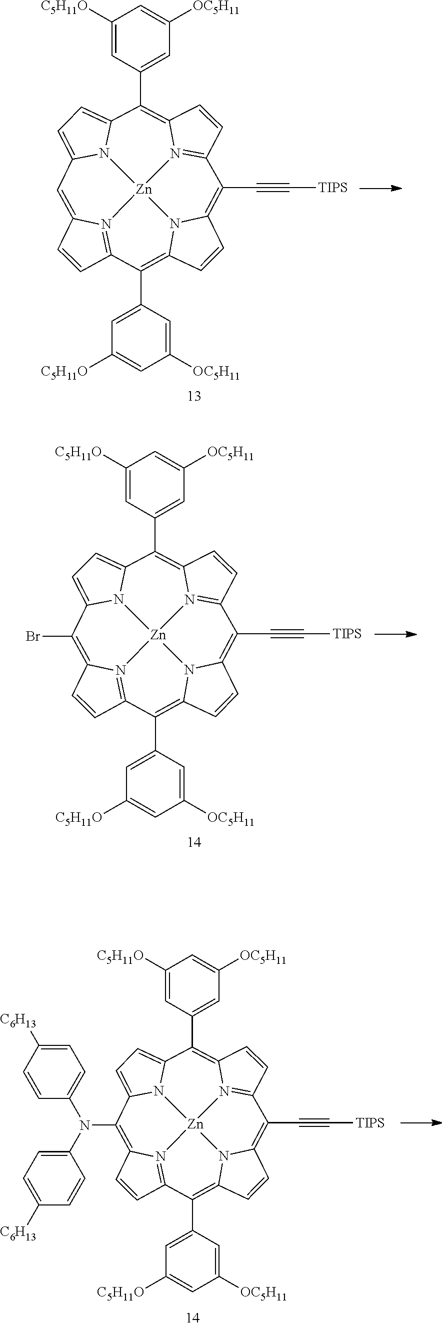

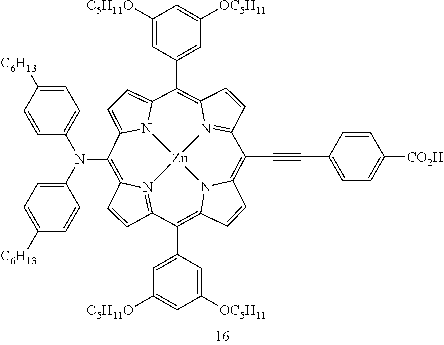

### i) 5,15-Bis(3,5-bis(3-methylbutoxy)phenyl)porphyrin, Compound 11

A suspension of dipyrromethane (6.00 g, 41.1 mmol) and 3,5-di(isopentyloxy)benzaldehyde (11.4 g, 41.1 mmol) was added to dichloromethane (5.4 L) and stirred under nitrogen atmosphere; and then deoxidized with nitrogen for 30 minutes. Trifluoroacetic acid TFA (2.75 mL, 37.0 mmol) was charged. The reaction was carried out for 3.5 hours; and then 2,3-dichloro-5,6-dicyano-1,4-benzoquinone DDQ (13.99 g, 61.6 mmol) was added. After the reaction was performed for 1 hour, the solvents were removed under concentration to obtain a residue. The residue was purified by Silica Gel Column Chromatography using dichloromethane/n-hexane (1:1), and then was recrystallized from methanol/dichloromethane, to give Compound 11 as a purple solid (4.9 g, 30%).

The purple solid was identified and assayed, and the result was shown as follows: ¹H NMR (CdCl₃, 400 MHz) δ_{H}=10.32 (d, J=12.8 Hz, 2H), 9.39 (d, J=5.2 Hz, 4H), 9.20 (d, J=4.4 Hz, 4H), 7.43 (d, J=2.4 Hz, 4H), 6.92 (t, J=2 Hz, 2H), 4.19 (t, J=6.8 Hz, 8H), 1.96-1.86 (m, 4H), 1.82-1.77 (m, 8H), 1 (d, J=6.8 Hz, 24H).

### ii) (5-Bromo-10,20-bis(3,5-bis(3-methylbutoxy)phenyl)porphyrinato)zinc(II), Compound 12

Compound 11 (1 g, 1.24 mmol) was added to dichloromethane (638 mL) and stirred under nitrogen atmosphere. The solution was placed in an ice bath for 20 minutes. To the thus-prepared solution of Compound 11 was added dropwise a solution of N-bromosuccinimide NBS (198 mg, 1.24 mmol) which was completely dissolved in dichloromethane (80 mL); and was reacted. The reaction was traced by spotting the solution on a thin layer chromatography (TLC) plate and quenched with acetone. The resulting crude product was purified by Silica Gel Column Chromatography using dichloromethane/n-hexane (1:2), to give an intermediate product as a purple-red solid (581 mg, 53%).

The intermediate product was identified and assayed, and the result was shown as follows: ¹H NMR (CdCl₃, 400 MHz) δ_{H}=10.16 (s, 1H), 9.73 (d, J=5.2 Hz, 2H), 9.28 (d, J=4.4 Hz, 2H), 9.09-9.07 (m, 4H), 7.38 (d, J=2.4 Hz, 4H), 6.92 (s, 2H), 4.18 (t, J=6.4 Hz, 8H), 1.94-1.87 (m, 4H), 1.87-1.76 (m, 8H), 1.00 (d, J=6.4 Hz, 24H), −3.03 (s, 2H).

Compound 12 was prepared under the reaction conditions described on Y. Xie et al, J. Phys. Chem. C 2008, 112, 10559, and K. Nakamura et al Chem. Lett. 2003, 32, 694.

In the organic layer, the intermediate product was dissolved in dichloromethane (270 mL); and then Zn(OAc)₂.2H₂O (1.45 g, 6.56 mmol) dissolved in methanol (54 mL) was added, to obtain a solution. Sequentially, the solution was stirred for 3 hours and extracted with water (200 mL). The extracts in the organic layer were combined and dried over anhydrous MgSO₄. The solvent was removed under concentration, to give Compound 12 (572 mg, 92%).

Compound 12 was identified and assayed, and the result was shown as follows: ¹H NMR (CdCl₃, 400 MHz) δ_{H}=10.18 (s, 1H), 9.79 (d, J=4.4 Hz, 2H), 9.34 (d, J=4.0 Hz, 2H), 9.25-9.10 (m, 4H), 7.36 (d, J=2.0 Hz, 4H), 6.89 (t, J=2.0 Hz, 2H), 4.16 (t, J=6.8 Hz, 8H), 1.96-1.83 (m, 4H), 1.83-1.73 (m, 8H), 0.99 (d, J=6.8 Hz, 24H). ¹³C NMR (CdCl₃, 100 MHz) δ_{C}=158.1, 150.3, 150.1, 149.2, 143.9, 133.1, 132.9, 132.7, 131.9, 120.9, 114.5, 106.3, 104.8, 101.0, 66.8, 38.1, 25.1, 22.7. MALDI-TOF: m/z calcd for C₅₂H₅₉BrN₄O₄Zn 948. found 948 [M]⁺.

### iii) (5-(Triisopropylsilyl)ethynyl-10,20-bis(3,5-bis(3-methylbutoxy)phenyl)porphyrinato)Zinc(II), Compound 13

A mixture of Compound 12 (1.05 mmol), triisopropylacetylene (1.26 mmol), Pd(PPh₃)₂Cl₂ (0.11 mmol), CuI(I) (0.11 mmol), tetrahydrofuran (32.8 mL) and triethylamine (6.5 mL) was gently stirred, refluxed and reacted under nitrogen atmosphere for 4 hours. Then, the solvent was removed under vacuum to obtain a residue. The residue was purified by Silica Gel Column Chromatography using dichloromethane/n-hexane (1:2), to yield Compound 13 as a purple solid (0.97 g, 88%).

Compound 13 was identified and assayed, and the result was shown as follows: ¹H NMR (CdCl₃, 400 MHz): δ_{H}=10.20 (s, 1H), 9.85 (d, J=4.4 Hz, 2H), 9.34 (d, J=4.4 Hz, 2H), 9.17 (d, J=4.4 Hz, 2H), 9.15 (d, J=4.4 Hz, 2H), 7.38 (d, J=2.0 Hz, 4H), 6.89 (t, J=2.4 Hz, 2H), 4.16 (d, J=6.8 Hz, 8H), 1.98-1.83 (m, 4H), 1.83-1.72 (m, 8H), 1.54-1.37 (m, 21H), 0.99 (d, J=6.8 Hz, 24H); ¹³C NMR (CdCl₃, 100 MHz): δ_{C}=158.2, 152.4, 150.2, 149.7, 149.6, 144.0, 133.0, 132.5, 131.8, 131.0, 121.3, 114.4, 109.6, 107.3, 101.0, 100.5, 66.8, 38.1, 25.1, 22.7, 19.1, 11.9. MALDI-TOF: m/z calcd for C₆₃H₈₀N₄O₄SiZn 1050. found 1050 [M]⁺.

### iv) (5-Bromo-15-(triisopropylsilyl)ethynyl-10,20-bis(3,5-bis(3-methylbutoxy)phenyl)porphyrinato)Zinc(II), Compound 14

To a stirred solution of Compound 13 (0.48 mmol) in dichloromethane (265 mL) and pyridine (26.5 mL) was added N-bromosuccinimide (127.0 mg, 0.71 mmol) and stirred for 0.5 hour at 23° C. The solvent was removed under reduced pressure to obtain a residue. The residue was purified by Silica Gel Column Chromatography using dichloromethane/n-hexane, to yield Compound 14 (0.48 g, 90%).

Compound 14 was identified and assayed, and the result was shown as follows: ¹H NMR (CdCl₃, 400 MHz): δ_{H}=9.74 (d, J=4.8 Hz, 2H), 9.68 (d, J=4.8 Hz, 2H), 9.05 (d, J=4.8 Hz, 2H), 9.02 (d, J=4.8 Hz, 2H), 7.32 (d, J=2.4 Hz, 4H), 6.87 (t, J=2.4 Hz, 2H), 4.15 (t, J=6.8 Hz, 8H), 1.98-1.82 (m, 4H), 1.82-1.72 (m, 8H), 1.55-1.36 (m, 21H), 0.99 (d, J=6.4 Hz, 24H); ¹³C NMR (CdCl₃, 100 MHz): δ_{C}=158.2, 153.2, 150.7, 150.0, 149.5, 143.8, 133.3, 133.1, 132.9, 131.3, 122.3, 114.4, 101.0, 66.8, 38.1, 25.1, 22.7, 19.1, 11.9. MALDI-TOF: m/z calcd for C₆₃H₇₉BrN₄O₄SiZn 1128. found 1128 [M]⁺.

### v) (5-Bis(4-hexylphenyl)amino-15-(triisopropylsilyl)ethynyl-10,20-bis(3,5-bis(3-methyl butoxy)phenyl)porphyrinato)Zinc(II), Compound 15

A mixture of bis(4-hexylphenyl)amine (1.77 mmol) and 60% NaH (1.77 mmol), Compound 14 (0.44 mmol), DPEphos (0.177 mmol) and Pd(OAc)₂ (0.11 mmol) in dry tetrahydrofuran (100 mL) was gently refluxed and reacted for 4 hours under nitrogen atmosphere. After the completion of the reaction, the solvent was removed under vacuum to obtain a residue. The residue was purified by Silica Gel Column Chromatography using dichloromethane/n-hexane, to yield Compound 15 (0.35 g, 57%).

Compound 15 was identified and assayed, and the result was shown as follows: ¹H NMR (CdCl₃, 400 MHz): δ_{H}=9.73 (d, J=4.4 Hz, 2H), 9.26 (d, J=4.4 Hz, 2H), 9.03 (d, J=4.4 Hz, 2H), 8.87 (d, J=4.8 Hz, 2H), 7.30 (d, J=2.0 Hz, 4H), 7.20 (d, J=8.8 Hz, 4H), 6.96 (d, J=8.4 Hz, 4H), 6.84 (t, J=2.4 Hz, 2H), 4.13 (t, J=6.8 Hz, 8H), 2.47 (t, J=7.6 Hz, 4H), 1.95-1.80 (m, 4H), 1.79-1.70 (m, 8H), 1.58-1.40 (m, 21H), 1.36-1.20 (m, 16H), 0.97 (d, J=6.4 Hz, 24H), 0.92-0.80 (m, 6H); ¹³C NMR (CdCl₃, 100 MHz): δ_{C}=158.3, 152.9, 152.7, 150.6, 149.9, 149.4, 143.9, 135.0, 133.0, 130.9, 130.8, 128.9, 124.4, 122.1, 121.7, 114.2, 109.4, 101.0, 100.6, 97.9, 66.8, 38.1, 35.2, 31.7, 31.5, 29.1, 25.1, 22.7, 22.6, 19.1, 14.1, 11.9. MALDI-TOF: m/z calcd for C₈₇H₁₁₃N₅O₄SiZn 1385. found 1385 [M]⁺.

### vi) (5,15-bis(3,5-bis(3-methylbutoxy)phenyl)-10-(bis(4-hexylphenyl)amino)-20-(4-carboxyphenylethynyl)porphyrinato)Zinc(II), Compound 16

To a solution of Compound 15 (0.072 mmol) in dry tetrahydrofuran (10 mL) was added tetrabutylammonium fluoride TBAF (0.72 mL, 1M in THF); and stirred, reacted at 23° C. under nitrogen atmosphere for 30 minutes. The reaction was quenched with H₂O; and then the resulting solution was extracted with dichloromethane. The extracts in the organic layer were combined and dried over anhydrous MgSO₄. The solvent was removed under reduced pressure to obtain a residue. A mixture of the residue and 4-iodobenzoic acid (0.29 mmol) was dissolved in a solvent mixture of tetrahydrofuran (35.5 mL) and triethylamine (7.1 mL). After the thus-forming solution was degassed with nitrogen for 10 minutes, tris(dibenzylideneacetone)dipalladium(0) Pd₂(dba)₃ (0.014 mmol) and AsPh₃ (0.14 mmol) were added to the solution. The solution was refluxed for 4 hours under nitrogen atmosphere, and the solvent was removed under reduced pressure to obtain a residue. The residue was purified by Silica Gel Column Chromatography using dichloromethane/methanol (20:1); and then recrystallized from n-hexane/ethanol, to give Compound 16 as a green solid (87 mg, 90%).

Compound 16 was identified and assayed, and the result was shown as follows: ¹H NMR (CdCl₃, 400 MHz): δ_{H}=9.75 (d, J=4.8 Hz, 2H), 9.26 (d, J=4.4 Hz, 2H), 9.07 (d, J=4.4 Hz, 2H), 8.87 (d, J=4.8 Hz, 2H), 8.29 (d, J=8.4 Hz, 2H), 8.12 (d, J=8.4 Hz, 2H), 7.32 (d, J=2.4 Hz, 4H), 7.2 (d, J=8.8 Hz, 4H), 6.97 (d, J=8.4 Hz, 4H), 6.86 (s, 2H), 4.14 (t, J=6.4 Hz, 8H), 2.48 (t, J=8.0 Hz, 4H), 1.97-1.80 (m, 4H), 1.80-1.70 (m, 8H), 1.36-1.18 (m, 16H), 0.97 (t, J=6.8 Hz, 24H), 0.84 (t, J=6.4 Hz, 6H); ¹³C NMR (CdCl₃, 100 MHz): δ_{C}=158.2, 152.7, 152.4, 150.6, 149.8, 149.5, 143.9, 135.0, 133.0, 131.2, 130.9, 130.5, 130.2, 129.2, 128.9, 124.7, 122.1, 121.9, 114.3, 100.9, 99.3, 96.2, 95.6, 66.7, 38.1, 35.2, 31.7, 31.5, 29.7, 29.1, 25.1, 22.6, 14.1; ESI-MS: m/z calcd for C₈₅H₉₇N₅O₆Zn 1349. found 1349 [M]⁺.

### Example 3

### Synthesis of Porphyrin Compound 23

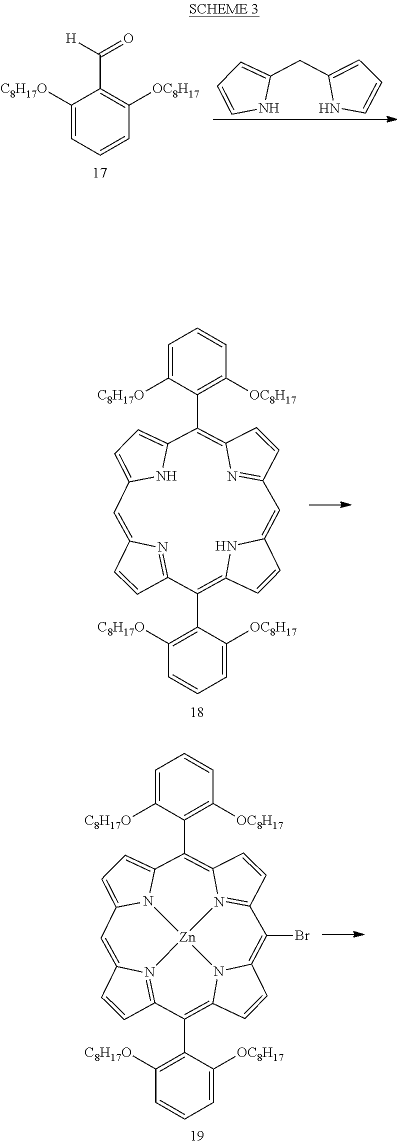

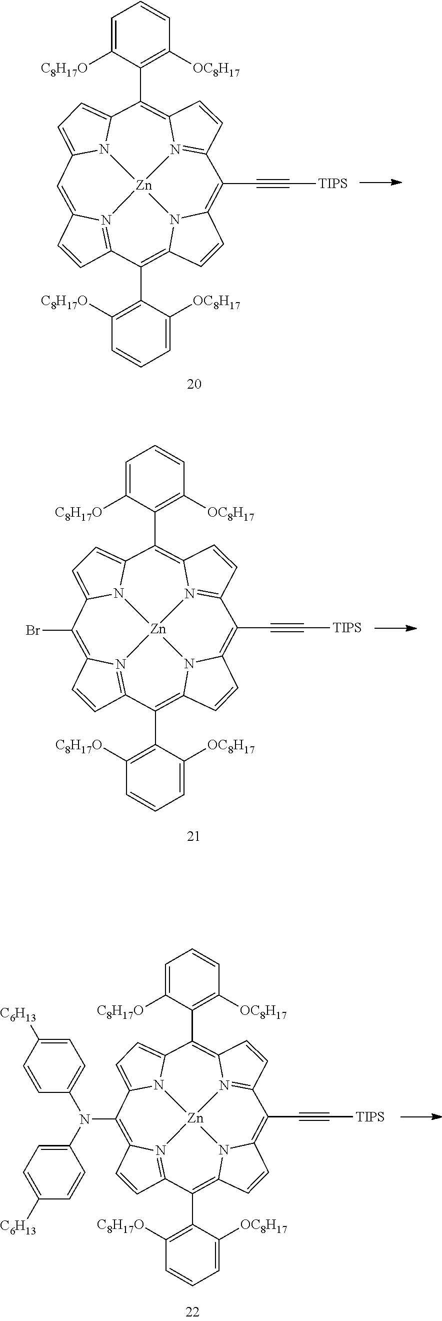

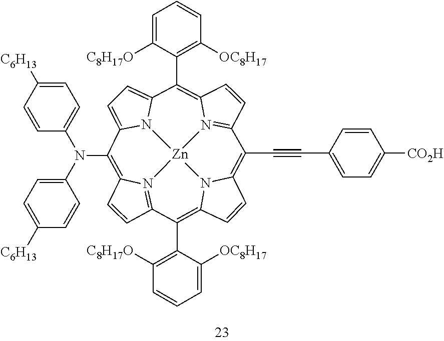

Compound 23 was prepared in the manner of the preparation for Compound 16 described above.

### i) (10,20-Bis(2,6-dioctyloxyphenyl)porphyrinato)Zinc(II), Compound 18

A mixture of dipyrromethane (6.04 g, 41.4 mmol), 2,6-bis(octyloxy)benzaldehyde (15.0 g, 41.4 mmol) was added to dichloromethane (5.40 L), stirred and was deoxidized with nitrogen for 30 minutes. To the solution was charged TFA (2.75 mL) and reacted for 3.5 hours under nitrogen atmosphere. After charging 2,3-dichloro-5,6-dicyano-1,4-benzoquinone DDQ (14.00 g, 61.7 mmol), the reaction was performed for an additional 1 hour. The solvent was removed under concentration to obtain a residue. The residue was purified by Silica Gel Column Chromatography using dichloromethane/n-hexane (1:2); and recrystallized from methanol/dichloromethane, to give Compound 18 as a purple solid (6.25 g, 30.7%).

Compound 18 was identified and assayed, and the result was shown as follows: ¹H NMR (CdCl3, 400 MHz) δ_{H}=10.15 (s, 2H), 9.26 (d, J=4.8 Hz, 4H), 8.98 (d, J=4.8 Hz, 4H), 7.71 (t, J=8.4 Hz, 2H), 7.02 (dd, J=2.4 Hz, J=8.4 Hz, 4H), 3.83 (t, J=6.4 Hz, 8H), 0.95-0.88 (m, 8H), 0.87-0.82 (m, 8H), 0.68-0.61 (m, 8H), 0.59-0.54 (m, 28H), 0.49-0.42 (m, 8H), −3.02 (s, 2H). ¹³C NMR (CdCl₃, 100 MHz) δ_{C}=160.6, 148.1, 145.4, 131.2, 130.8, 130.4, 120.5, 112.0, 105.8, 104.4, 69.2, 31.7, 29.1, 25.7, 22.7, 14.3. MALDI-TOF-MS: m/z calcd for C₆₄H₈₆N₄O₄ 974. found 975 [M+H]⁺.

### ii) (5-Bromo-10,20-bis(2,6-dioctyloxyphenyl)porphyrinato)Zinc(II), Compound 19

Compound 18 (3.5 g, 3.59 mmol) was added to dichloromethane (1500 mL), stirred and deoxidized with nitrogen for 20 minutes. In an ice bath, to the thus-obtained solution of Compound 18 was added dropwise NBS (671 mg, 3.77 mmol) which was completely dissolved in dichloromethane (400 mL) and reacted. The reaction was traced by spotting the solution on TLC plate; and then quenched with acetone. The solvents were removed under concentration to obtain a residue. The residue was purified by Silica Gel Column Chromatography using dichloromethane/n-hexane (1:4), to give an intermediate product as a purple-red solid (2.3 g, 61%).

The intermediate product was identified and assayed, and the result was shown as follows: ¹H NMR (CdCl₃, 400 MHz) δ_{H}=10.01 (s, 1H), 9.62 (d, J=4.8 Hz, 2H), 9.17 (d, J=4.0 Hz, 2H), 8.88 (t, J=4.4 Hz, 4H), 7.70 (t, J=8.0 Hz, 2H), 7.01 (dd, J=3.2 Hz, J=8.4 Hz, 4H), 3.84 (t, J=6.4 Hz, 8H), 0.97-0.90 (m, 8H), 0.86-0.79 (m, 8H), 0.67-0.60 (m, 8H), 0.58-0.49 (m, 28H), 0.47-0.39 (m, 8H), −2.89 (s, 2H). ¹³C NMR (CdCl₃, 100 MHz) δ_{C}=160.5, 132.3, 131.8, 130.6, 120.4, 113.3, 105.6, 104.7, 102.6, 69.1, 31.8, 29.1, 29.0, 25.8, 25.7, 22.7, 14.3. MALDI-TOF-MS: m/z calcd for C₆₄H₈₅BrN₄O₄ 1054. found 1054 [M]⁺.

After the intermediate product was dissolved with CH₂Cl₂ (450 mL), a solution of Zn(OAc)₂.2H₂O (4.79 g, 21.82 mmol) in MeOH (450 mL) was added; and then was stirred and reacted for 1 hour. The solvents were removed under concentration to obtain a residue. The residue was added with water and then filtered, to give Compound 19 as a purple-red solid (3.63 g, 98%).

Compound 19 was identified and assayed, and the result was shown as follows: ¹H NMR (CdCl₃, 400 MHz) δ_{H}=10.17 (d, J=2 Hz, 1H), 9.80 (d, J=4.8 Hz, 2H), 9.34 (d, J=4.8 Hz, 2H), 9.07 (t, J=4.4 Hz, 4H), 7.76 (t, J=8.0 Hz, 2H), 7.07 (dd, J=2.4 Hz, J=8.4 Hz, 4H), 3.91 (t, J=6.4 Hz, 8H), 1.03-0.97 (m, 8H), 0.88-0.80 (m, 8H), 0.66-0.40 (m, 44H). ¹³C NMR (CdCl3, 100 MHz) δ 160.5, 151.5, 151.4, 150.4, 149.3, 132.9, 132.8, 132.7, 132.6, 132.5, 132.1, 130.3, 121.5, 114.1, 105.8, 104.1, 69.1, 31.7, 29.1, 29.0, 25.7, 22.7, 14.3. MALDI-TOF-MS: m/z calcd for C₆₄H₈₃BrN₄O₄Zn 1116. found 1116 [M]⁺.

### iii) (5-(Triisopropylsilyl)ethynyl-10,20-bis(2,6-dioctyloxyphenyl)porphyrinato)Zinc(II), Compound 20

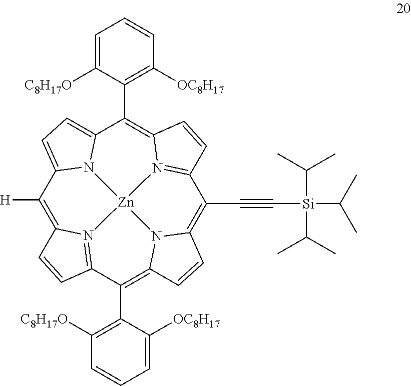

To a solution of Compound 19 (0.91 g, 0.81 mmol) in THF (30.0 mL) and Et₃N (5.0 mL) was added Pd(PPh₃)₂Cl₂ (110 mg, 0.16 mmol) and CuI(I) (47.0 mg, 0.24 mmol), and then (triisopropylsilyl)acetylene (0.37 mL, 2.04 mmol). The thus-obtained solution was refluxed for 3.5 hours under heating; and then was cooled to room temperature. The solvent was removed under concentration to obtain a residue. The residue was purified by Silica Gel Column Chromatography using CH₂Cl₂/n-hexane (1:4) and recrystallized from CH₂Cl₂/MeOH, to give Compound 20 as a solid (820 mg, 83%).

Compound 20 was identified and assayed, and the result was shown as follows: ¹H NMR (CDCl3, 400 MHz) δ 10.20 (s, 1H), 9.91 (d, J=4.4 Hz, 2H), 9.38 (d, J=4.4 Hz, 2H), 9.12 (d, J=4.8 Hz, 2H), 9.09 (d, J=4.8 Hz, 2H), 7.80 (t, J=8.4 Hz, 2H), 7.12 (d, J=8.8 Hz, 4H), 3.96 (t, J=6.4 Hz, 8H), 1.67-1.56 (m, 21H), 1.05-1.02 (m, 8H), 0.91-0.85 (m, 8H), 0.71-0.45 (m, 44H). ¹³C NMR (CDCl3, 100 MHz) δ 160.5, 152.6, 151.5, 150.9, 149.7, 132.5, 132.1, 131.9, 131.2, 130.3, 121.8, 114.3, 110.9, 106.9, 105.9, 99.6, 96.5, 69.3, 31.8, 29.1, 29.0, 25.7, 22.7, 19.7, 19.6, 19.2, 19.1, 14.3, 12.5, 12.3, 11.9. MALDI-TOF-MS: m/z calcd for C₇₅H₁₀₄N₄O₄SiZn 1218. found 1219 [M+H]⁺.

### iv) (5-Bromo-15-(triisopropylsilyl)ethynyl-10,20-bis(2,6-dioctyloxyphenyl)porphyrinato)Zinc(II), Compound 21

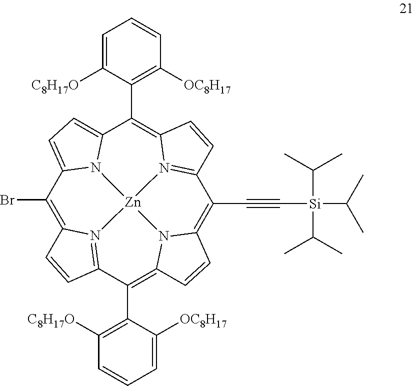

To a solution of Compound 20 (820 mg, 0.67 mmol) added with CH₂Cl₂ (250 mL) and pyridine (5.0 mL) was charged NBS (119 mg, 0.67 mmol) through an addition funnel; and was reacted for 30 minutes. The reaction was traced by spotting the solution on TLC plate. The reaction was quenched with acetone. The solvents were removed under concentration to obtain a residue. The residue was purified by Silica Gel Column Chromatography using CH₂Cl₂/n-hexane (1:4) and recrystallized from CH₂Cl₂/MeOH, to give Compound 21 as a solid (690.0 mg, 79%).

Compound 21 was identified and assayed, and the result was shown as follows: ¹H NMR (CdCl3, 400 MHz) δ 9.72 (d, J=4.8 Hz, 2H), 9.65 (d, J=4.4 Hz, 2H), 8.92 (d, J=4.4 Hz, 2H), 8.89 (d, J=4.4 Hz, 2H), 7.71 (t, J=8.0 Hz, 2H), 7.03 (d, J=8.4 Hz, 4H), 3.88 (t, J=6.4 Hz, 8H), 1.55-1.45 (m, 21H), 1.02-0.95 (m, 8H), 0.89-0.80 (m, 8H), 0.66-0.39 (m, 44H). ¹³C NMR (CdCl₃, 100 MHz) δ 160.4, 153.4, 151.9, 151.1, 149.4, 133.1, 132.9, 132.5, 131.5, 130.4, 121.4, 115.3, 110.4, 105.8, 105.5, 100.0, 97.0, 69.2, 31.8, 31.3, 29.1, 29.0, 25.7, 22.7, 19.6, 19.5, 14.3, 12.4, 12.2. MALDI-TOF-MS: m/z calcd for C₇₅H₁₀₃BrN₄O₄SiZn 1296. found 1297 [M+H]⁺.

### v) (5-Bis(4-hexylphenyl)amino-15-(triisopropylsilyl)ethynyl-10,20-bis(2,6-dioctyloxyphenyl)porphyrinato)Zinc(II), Compound 22

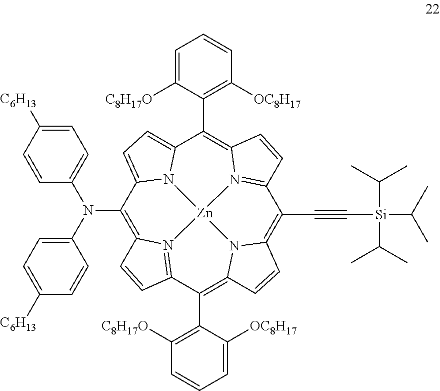

To a mixture of Compound 21 (330 mg, 0.25 mmol) dissolved in toluene (44.2 mL), Pd(OAc)₂ (14 mg, 0.06 mmol), DPEphos (50.0 mg, 0.09 mmol) and 60% NaH (40.0 mg, 1.02 mmol) in the reaction flask was charged a solution of bis(4-hexylphenyl)amine (340 mg, 1.02 mmol) dissolved in toluene (29.8 mL), and refluxed for 4 hours under heating; and then cooled to room temperature. The solvent was removed under concentration to obtain a residue. The residue was purified by Silica Gel Column Chromatography using CH₂Cl₂/n-hexane (1:4) and recrystallized from CH₂Cl₂/MeOH, to give Compound 22 as a solid (330.0 mg, 71%).

Compound 22 was identified and assayed, and the result was shown as follows: ¹H NMR (CDCl₃, 400 MHz) δ 9.66 (d, J=4.4 Hz, 2H), 9.19 (d, J=4.4 Hz, 2H), 8.86 (d, J=4.4 Hz, 2H), 8.70 (d, J=4.8 Hz, 2H), 7.64 (t, J=8.4 Hz, 2H), 7.22 (t, J=8.8 Hz, 4H), 6.94 (m, 8H), 3.82 (t, J=6.4 Hz, 8H), 2.46 (t, J=7.6 Hz, 4H), 1.55-1.52 (m, 4H), 1.49-1.43 (m, 21H), 1.27 (t, 12H), 1.01-0.94 (m, 8H), 0.88-0.76 (m, 22H), 0.65-0.43 (m, 44H). ¹³C NMR (CdCl3, 100 MHz) δ 160.3, 152.9, 152.4, 151.0, 150.9, 150.6, 135.1, 132.5, 132.4, 131.0, 130.9, 130.2, 129.1, 123.3, 122.4, 121.4, 114.7, 110.6, 105.7, 99.7, 96.6, 69.1, 35.7, 32.2, 32.0, 31.8, 31.4, 29.6, 29.0, 28.9, 25.6, 23.1, 22.7, 19.6, 19.5, 14.5, 14.2, 14.0, 12.4. MALDI-TOF-MS: m/z calcd for C₉₉H₁₃₇N₅O₄SiZn 1553. found 1554 [M+H]⁺.

### vi) Porphyrin Compound 23

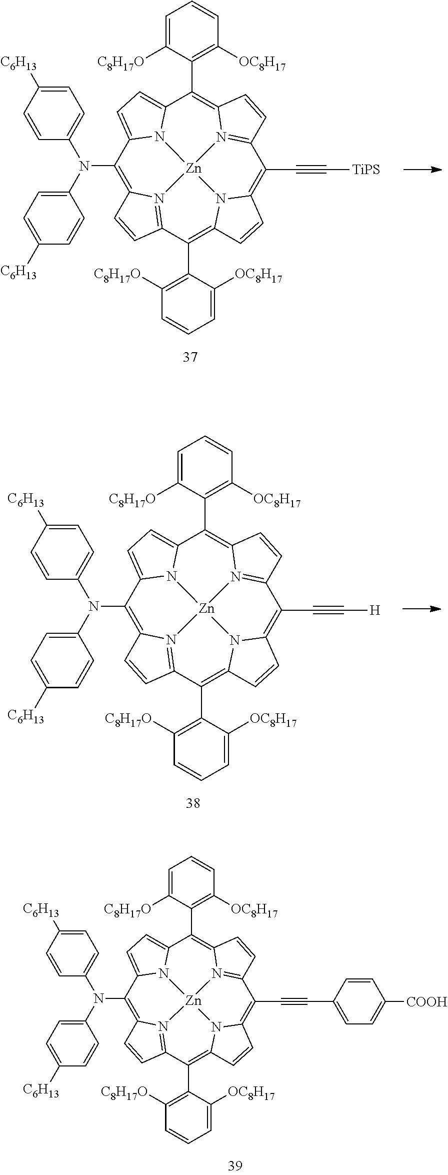

To a solution of Compound 22 (0.072 mmol) in dry tetrahydrofuran (10 mL) was added TBAF (0.72 mL, 1M in THF), stirred and reacted for 30 minutes at 23° C. under nitrogen atmosphere. The reaction was quenched with H₂O, and the resulting mixture was extracted with CH₂Cl₂. The extracts in the organic layer were combined and dried over anhydrous MgSO₄. The solvent was removed under reduced pressure, to give an Intermediate M.

A mixture of Intermediate M and 4-iodobenzoic acid (0.29 mmol) was dissolved together in a solvent mixture of dry THF (35.5 mL) and NEt₃ (7.1 mL); and then was degassed with nitrogen for 10 minutes. To the thus-obtained solution was added Pd₂(dba)₃ (0.014 mmol) and AsPh₃ (0.14 mmol), and refluxed for 4 hours under nitrogen atmosphere. The solvent was removed under reduced pressure to obtain a residue. The residue was purified by Silica Gel Column Chromatography using CH₂Cl₂/CH₃OH (20:1) and recrystallized from n-hexane/ethanol, to yield Compound 23 as a green solid (77%).

Compound 23 was identified and assayed, and the result was shown as follows: ¹H NMR (CdCl₃, 400 MHz) δ_{H}=9.57 (d, J=4.8 Hz, 2H), 9.00 (d, J=4.4 Hz, 2H), 8.79 (d, J=4.4 Hz, 2H), 8.58 (d, J=4.8 Hz, 2H), 8.26 (d, J=8.4 Hz, 2H), 7.99 (d, J=8.0 Hz, 2H), 7.61 (t, J=8.4 Hz, 2H), 6.98 (d, J=8.0 Hz, 4H), 6.93 (d, J=8.4 Hz, 4H), 6.77 (d, J=8.4 Hz, 4H), 3.79 (t, J=6.4 Hz, 8H), 2.38 (t, J=7.6 Hz, 4H), 1.47 (s, 4H), 1.21 (s, 12H), 0.89 (t, J=7.6 Hz, 16H), 0.83-0.71 (m, 14H), 0.71-0.36 (m, 36H). ¹³C NMR (CdCl₃, 100 MHz) δ_{C}=160.4, 152.5, 152.4, 151.0, 150.8, 135.1, 132.7, 132.5, 132.0, 131.7, 131.0, 130.8, 130.6, 130.4, 130.3, 129.9, 129.2, 123.8, 122.4, 121.4, 115.0, 109.2, 105.7, 98.4, 97.6, 95.1, 69.1, 35.7, 32.2, 31.9, 31.3, 30.2, 30.0, 29.6, 29.1, 28.9, 25.6, 23.1, 22.7, 14.5, 14.3. MALDI-TOF: m/z calcd for C₉₇H₁₂₁N₅O₆Zn 1517. found 1518 [M+1]⁺.

### Example 4

### Synthesis of Porphyrin Compound 30

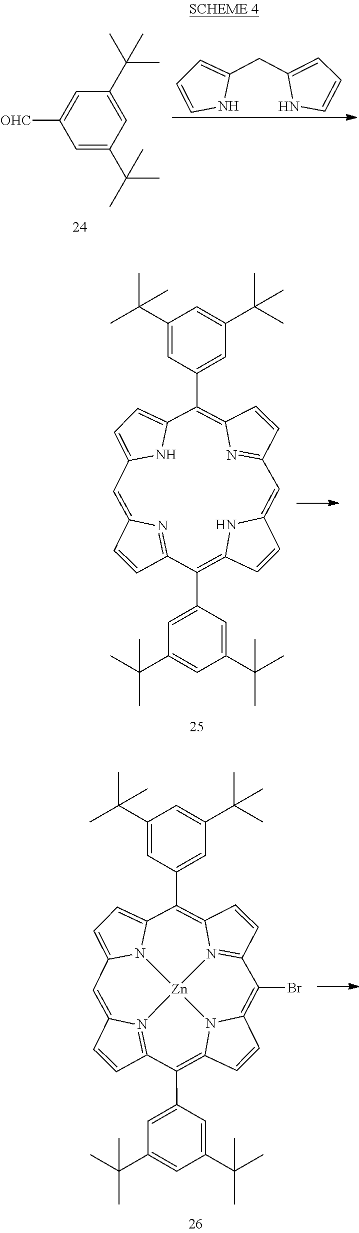

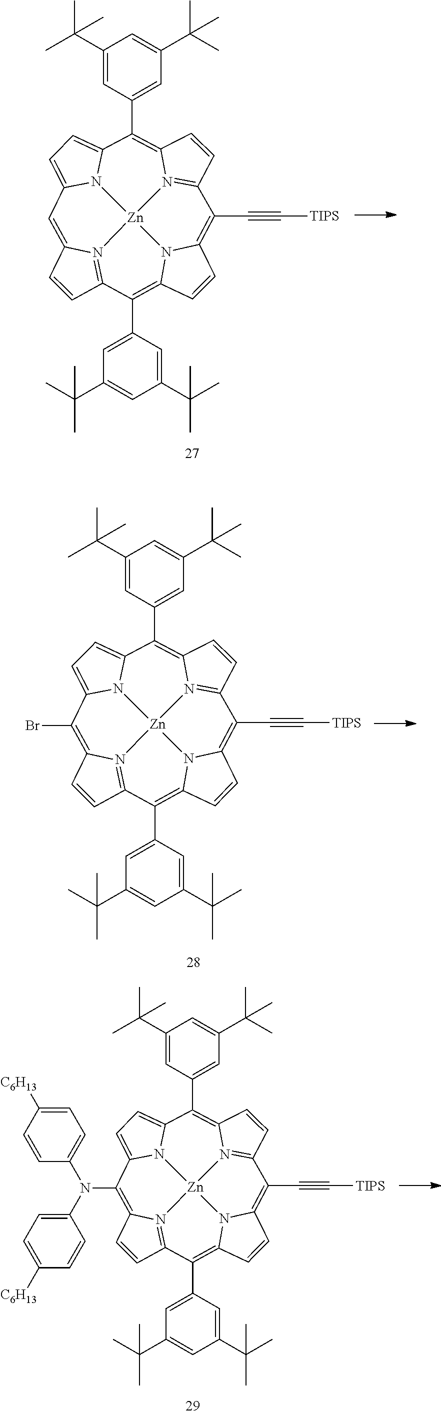

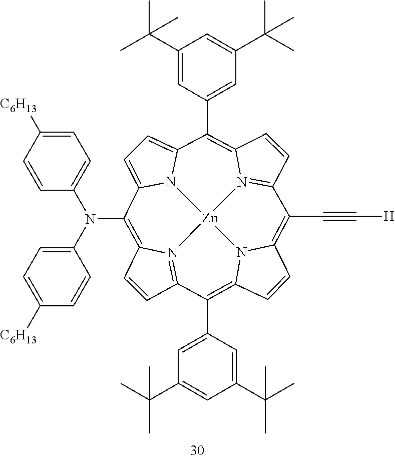

### i) 3,5-Di-tert-butylbenzaldehyde, Compound 24

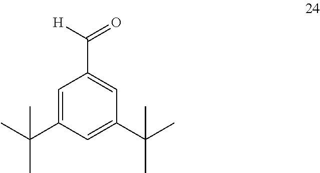 [SMILES: CC(C)(C)c1cc(C=O)cc(C(C)(C)C)c1]

Compound 24 was prepared under the reaction conditions described on M. J. Plater, S. Aiken, G. Bourhill, Tetrahedron. 2002, 58, 2405.

To 3,5-di-tert-butyl(bromomethyl)benzene (30.0 g, 0.11 mol) was added a solution of MeOH/H₂O (120 mL, 1:1), and then charged hexamethylenetetramine (62.0 g, 0.44 mol). The thus-obtained solution was heated and refluxed for 4 hours. To the solution was added concentrated hydrochloric acid (36 mL) in an ice bath. The solution was refluxed for 30 minutes under heating; and then was extracted with CH₂Cl₂ and recrystallized from EtOH/H₂O, to give Compound 24 as a milky white solid (15.0 g, 65%).

Compound 24 was identified and assayed, and the result was shown as follows: ¹H NMR (CdCl₃, 400 MHz) δ 10.00 (s, 1H), 7.72 (d, J=1.6 Hz, 2H), 7.71 (d, J=1.6 Hz, 1H), 1.36 (s, 18H).

### ii) 5,15-Bis(3,5-di-tert-butylphenyl)porphyrin, Compound 25

Compound 25 was prepared based on the disclosures of Yoshida et al, Chem. Eur. J. 2003, 9, 58 and H. Shinmori et al, Angew. Chem., Int. Ed. 2003, 42, 2754.

A mixture of 3,5-di-tert-butylbenzaldehyde (8.3 g, 38 mmol), dipyrromethane (5.6 g, 38.3 mmol) was added to dichloromethane (5.0 L), and stirred. The thus-obtained solution was deoxidized with nitrogen for 30 minutes. To the solution was added TFA (2.55 mL, 34.3 mmol) under nitrogen atmosphere, and reacted for 3.5 hours. To the reaction solution was added 2,3-dichloro-5,6-dicyano-1,4-benzoquinone DDQ (12.9 g, 56.8 mmol), and reacted for 1 hour. The solvent was removed under concentration to obtain a residue. The residue was purified by Silica Gel Column Chromatography using dichloromethane/n-hexane (1:1) and recrystallized from methanol/dichloromethane, to give Compound 25 as a purple solid (4.1 g, 35%).

Compound 25 was identified and assayed, and the result was shown as follows: ¹H NMR (CdCl₃, 400 MHz) δ_{H}=10.32 (s, 2H), 9.41 (d, J=4.8 Hz, 4H), 9.15 (d, J=4.4 Hz, 4H), 8.16 (d, 4H), 7.84 (t, 2H), 1.58 (s, 36H), −3.02 (s, 2H).

### iii) (5-Bromo-10,20-bis(3,5-di-tert-butylphenyl)porphyrinato)Zinc(II), Compound 26

Compound 26 was prepared based on the disclosure of M. J. Plater et al, Tetrahedron. 2002, 58, 2405.

A solution of Compound 25 (1 g, 1.46 mmol) added to dichloromethane (750 mL) was stirred and deoxidized with nitrogen for 20 minutes. In an ice bath, to the solution of Compound 25 was added dropwise N-bromosuccinimide NBS (259 mg, 1.46 mmol) which was dissolved in CH₂Cl₂ (94 mL), and reacted. The reaction was traced by spotting the solution on TLC plate, and quenched with acetone. The solvents were removed under concentration to obtain a residue. The residue was purified by Silica Gel Column Chromatography using dichloromethane/n-hexane (1:4), to give an intermediate product as a purple-red solid (600 mg, 54%).

The intermediate product was identified and assayed, and the result was shown as follows: ¹H NMR (CdCl₃, 400 MHz) δ_{H}=10.19 (s, 1H), 9.76 (d, J=4.8 Hz, 2H), 9.30 (d, J=4.8 Hz, 2H), 9.02 (d, J=4.8 Hz, 4H), 8.09 (d, J=4.8 Hz, 4H), 7.84 (s, 2H), 1.56 (s, 36H), −2.94 (s, 2H).

After the intermediate product was dissolved in CH₂Cl₂, a solution of Zn(OAc)₂.2H₂O in MeOH was added. The thus-obtained solution was stirred, heated, refluxed for 1 hour, and concentrated. The resulting solution was shaken with water for 10 minutes and then filtered, to give Compound 26 as a purple-red solid (610 mg, 94%).

Compound 26 was identified and assayed, and the result was shown as follows: ¹H NMR (CdCl₃, 400 MHz) δ_{H}=10.25 (s, 1H), 9.83 (d, J=4.8 Hz, 2H), 9.38 (d, J=4.8 Hz, 2H), 9.10 (dd, J=5.2, 4.4 Hz, 4H), 8.09 (d, 4H), 7.84 (s, 2H), 1.55 (s, 36H).

### iv) (5-(Triisopropylsilyl)ethynyl-10,20-bis(3,5-di-tert-butylphenyl)porphyrinato)Zinc(II), Compound 27

A solution of Compound 26 (1.63 g, 1.966 mmol) dissolved in tetrahydrofuran (400 mL) and Et₃N (45 mL) was deoxidized with nitrogen for 15 minutes. To the solution was added bis(triphenyl phosphine)palladium dichloride (144 mg, 0.20 mmol) and CuI(I) (42 mg, 0.02 mmol); and then charged (triisopropylsilyl)acetylene (2.4 mL, 8.16 mmol). The thus-obtained solution was heated, refluxed for 3.5 hours and then cooled to room temperature. The solvent was removed under concentration to obtained a residue. The residue was purified by Silica Gel Column Chromatography using CH₂Cl₂/n-hexane (1:4) and recrystallized from dichloromethane/methanol, to give Compound 27 as a solid (1.56 g, 85%).

Compound 27 was identified and assayed, and the result was shown as follows: ¹H NMR (CdCl₃, 400 MHz) δ_{H}=10.22 (s, 1H), 9.86 (d, J=4.8 Hz, 2H), 9.35 (d, J=4.8 Hz, 2H), 9.10 (d, J=4.4 Hz, 4H), 9.08 (d, J=4.4 Hz, 2H), 8.09 (d, J=2.0 Hz, 4H), 7.83 (d, J=2.0 Hz, 2H), 1.57 (s, 36H), 1.46-1.45 (m, 21H).

### v) (5-Bromo-15-(triisopropylsilyl)ethynyl-10,20-bis(3,5-di-tert-butylphenyl)porphyrinato)Zinc(II), Compound 28

To a solution of Compound 27 (500 mg, 0.54 mmol) added to CHCl₃ (300 mL) and pyridine (30 mL) was charged NBS (143 mg, 0.804 mmol), and reacted for 2 minutes. The reaction was quenched with acetone. The solvent was removed under concentration to obtain a residue. The residue was purified by Silica Gel Column Chromatography using CH₂Cl₂/n-hexane (1:4) and recrystallized from dichloromethane/methanol, to give Compound 28 as a solid (475 mg, 88%).

Compound 28 was identified and assayed, and the result was shown as follows: ¹H NMR (CdCl₃, 400 MHz) δ_{H}=9.78 (d, J=5.2 Hz, 2H), 9.70 (d, J=4.8 Hz, 2H), 9.00 (d, J=4.8 Hz, 2H), 8.97 (d, J=4.8 Hz, 2H), 8.03 (d, J=2.0 Hz, 4H), 7.82 (d, J=2.0 Hz, 2H), 1.55 (s, 36H), 1.44-1.43 (m, 21H).

### vi) (5-Bis(4-hexylphenyl)amino-15-(triisopropylsilyl)ethynyl-10,20-bis(3,5-di-tert-butylphenyl)porphyrinato)Zinc(II), Compound 29

Bis(4-hexylphenyl)amine (58.5 mg, 0.173 mmol) and 60% NaH (28 mg, 0.42 mmol) were dissolved in tetrahydrofuran (5 mL), and stirred for 5 minutes. To the solution was added a mixture of Compound 28 (50 mg, 0.0495 mmol), Pd(OAc)₂ (2.2 mg, 0.0098 mmol) and DPEphos (8.0 mg, 0.0148 mmol). The resulting solution was refluxed for 5 hours under heating, and then cooled to room temperature. The solvent was removed under concentration to obtain a residue. The residue was purified by Silica Gel Column Chromatography using dichloromethane/n-hexane (1:4) and recrystallized from dichloromethane/methanol, to give Compound 29 as a solid (42 mg, 67%).

Compound 29 was identified and assayed, and the result was shown as follows: ¹H NMR (CdCl₃, 400 MHz) δ_{H}=9.75 (d, J=4.8 Hz, 2H), 9.28 (d, J=4.8 Hz, 2H), 8.95 (d, J=4.8 Hz, 2H), 8.81 (d, J=4.8 Hz, 2H), 8.00 (d, J=1.6 Hz, 2H), 7.77 (d, J=1.6 Hz, 2H), 7.21 (d, J=8.4 Hz, 4H), 6.96 (d, J=8.4 Hz, 2H), 2.46 (t, J=7.6 Hz, 4H), 1.52 (s, 36H), 1.45 (m, 21H), 1.24 (m, 16H), 0.82 (t, J=7.2 Hz, 6H).

### vii) (5-Bis(4-hexylphenyl)amino-15-ethynyl-10,20-bis(3,5-di-tert-butylphenyl)porphyrinato)Zinc(II), Compound 30

To a solution of Compound 29 (25 mg, 0.02 mmol) dissolved in tetrahydrofuran (5 mL) was charged TBAF (1M in THF, 80 μL, 0.10 mmol), and reacted at room temperature for 30 minutes. The solvent was removed under concentration to obtain a residue. The residue was extracted with H₂O and dichloromethane. The extracts in the organic layer were combined and dried over anhydrous MgSO₄. The solvent was removed under concentration, to give Compound 30 (21.5 mg, 98%).

Compound 30 was identified and assayed, and the result was shown as follows: ¹H NMR (CdCl₃, 400 MHz) δ_{H}=9.67 (d, J=4.8 Hz, 2H), 9.26 (d, J=4.8 Hz, 2H), 8.94 (d, J=4.8 Hz, 2H), 8.80 (d, J=4.8 Hz, 2H), 8.00 (d, J=2.0 Hz, 4H), 7.77 (d, J=2.0 Hz, 2H), 7.22-7.20 (m, 4H), 6.97-6.95 (m, 4H), 4.13 (s, 1H), 2.47 (t, J=7.6 Hz, 4H), 1.52 (s, 36H), 1.24 (m, 16H), 0.82 (t, J=6.4 Hz, 6H).

### Example 5

### Synthesis of Porphyrin Compound 31

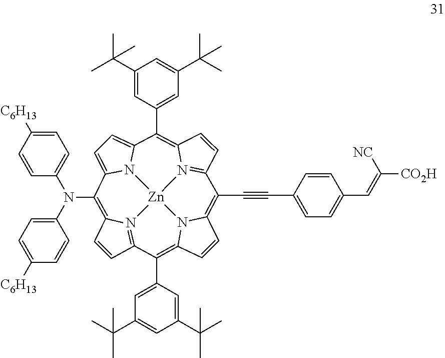

To a solution of Compound 29 (25 mg, 0.02 mmol) dissolved in THF (5 mL) was charged TBAF (1M in THF, 80 μL, 0.10 mmol); and reacted at room temperature for 30 minutes. The solvent was removed under concentration to obtain a residue. The residue was extracted with H₂O and dichloromethane. The extracts in the organic layer were combined and dried over anhydrous MgSO₄. The solvent was removed under concentration, to give an intermediate product (21.7 mg, 99%) for being employed in the next reaction step directly.

Compound 30 (21.7 mg) and (E)-2-cyano-3-(4-iodophenyl)acrylic acid (0.2 mmol) were dissolved in a solvent mixture of tetrahydrofuran (50 mL) and triethylamine (2 mL); and the thus-obtained solution was deoxidized with nitrogen for 10 minutes. To the deoxidized solution was added Pd₂(dba)₃ (0.012 mmol) and AsPPh₃ (0.08 mmol); and the solution was refluxed for 4 hours under heating. The reaction was cooled to room temperature; and the solvent was removed under concentration to obtain a residue. The residue was purified by Silica Gel Column Chromatography using CH₂Cl₂/MeOH (20:1), and recrystallized from CH₂Cl₂/n-hexane, to give Compound 31 as a solid (36 mg, 70.4%).

Compound 31 was identified and assayed, and the result was shown as follows: ¹H NMR (CdCl₃/pyridine-d₅, 400 MHz): δ_{H}=9.76 (d, J=4.8 Hz, 2H), 9.27 (d, J=4.8 Hz, 2H), 8.98 (d, J=4.8 Hz, 2H), 8.82 (d, J=4.8 Hz, 2H), 8.13 (d, J=8.4 Hz, 2H), 8.07 (d, J=8.0 Hz, 2H), 8.03 (d, J=2.0 Hz, 4H), 7.78 (t, J=3.6 Hz, 2H), 7.51 (s, 1H), 7.22 (d, J=8.4 Hz, 4H), 6.97 (d, J=8.4 Hz, 4H), 2.48 (t, J=7.6 Hz, 4H), 1.52 (s, 36H), 1.36 (m, 12H), 0.84 (t, J=6.4 Hz, 6H); ¹³C NMR (CdCl₃/pyridine-d₅, 100 MHz): δₑ=165.3, 152.1, 150.4, 150.1, 149.8, 148.2, 141.4, 134.4, 133.0, 132.8, 131.5, 130.9, 130.4, 129.8, 129.5, 128.9, 128.5, 124.0, 121.7, 120.5, 116.3, 114.3, 109.2, 105.1, 98.3, 97.8, 95.3, 35.0, 34.8, 31.5, 31.2, 28.8, 22.4, 13.9; UV-vis (THF): λmax/nm (ε, 10³M⁻¹cm⁻¹)=453(90), 587(6), 659(27). MALDI-TOF-MS: m/z calcd for C₈₄H₉₀N₆O₂Zn 1280. found 1280 ([M]⁺).

### Example 6

### Synthesis of Porphyrin Compound 32

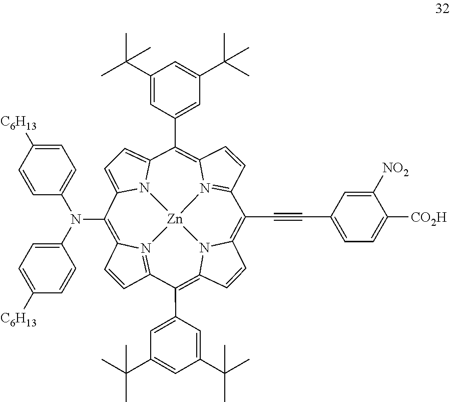

Compound 30 (0.16 mmol) and 4-bromo-2-nitrobenzoic acid (1.6 mmol) were dissolved in a solvent mixture of tetrahydrofuran (45 mL) and Et₃N (8 mL); and the solution was deoxidized with nitrogen for 10 minutes. To the deoxidized solution was added Pd₂(dba)₃ (0.048 mmol) and AsPPh₃ (0.32 mmol). The thus-obtained solution was refluxed for 4 hours under heating to perform the reaction. The reaction was cooled to room temperature. The solvent was removed under concentration to obtain a residue. The residue was purified by Silica Gel Column Chromatography using dichloromethane/methanol (20:1), to give Compound 32 as a solid (118 mg, 57.9%).

Compound 32 was identified and assayed, and the result was shown as follows: ¹H NMR (CdCl₃/pyridine-d₅, 400 MHz): δ_{H}=9.66 (d, J=4.8 Hz, 2H), 9.16 (d, J=4.8 Hz, 2H), 8.87 (d, J=4.4 Hz, 2H), 8.70 (d, J=4.4 Hz, 2H), 8.22 (s, 1H), 8.12 (s, 1H), 7.92 (d, J=1.6 Hz, 4H), 7.69 (s, 2H), 7.15 (d, J=8.4 Hz, 4H), 6.90 (d, J=8.4 Hz, 4H), 2.45 (t, J=8.0 Hz, 4H), 1.45 (s, 36H), 1.23 (m, 12H), 0.83 (t, J=6.4 Hz, 6H); ¹³C NMR (CdCl₃/pyridine-d₅, 100 MHz): δ_{c}=151.9, 150.4, 150.0, 149.6, 148.1, 141.3, 134.3, 133.8, 132.9, 132.7, 131.0, 130.3, 129.8, 129.4, 128.4, 126.0, 124.8, 123.9, 121.6, 120.4, 108.5, 97.4, 96.6, 93.2, 34.8, 34.6, 31.3, 31.1, 29.3, 28.7, 22.2, 13.7; UV-vis (THF): λₘₐₓ/nm (ε, 10³M⁻¹ cm⁻¹)=443(209), 586(10), 649(34). MALDI-TOF-MS: m/z calcd for C₈₁H₈₈N₆O₄Zn 1272. found 1272 ([M]⁺).

### Example 7

### Synthesis of Porphyrin Compound 33

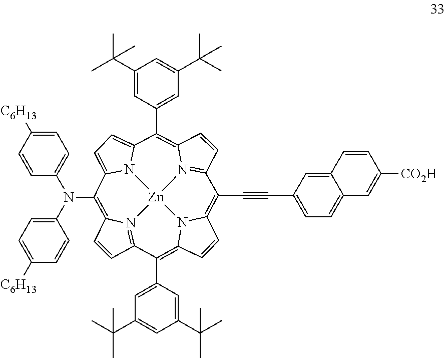

Compound 30 (0.08 mmol) and 6-bromo-2-naphthenic acid (0.8 mmol) were dissolved in tetrahydrofuran (25 mL) and Et₃N (4 mL); and the solution was deoxidized with nitrogen for 10 minutes. To the deoxidized solution was added Pd₂(dba)₃ (0.024 mmol) and AsPPh₃ (0.16 mmol). The resulting solution was refluxed overnight under heating; and then the reaction was cooled to room temperature. The solvent was removed under concentration to obtain a residue. The residue was purified by Silica Gel Column Chromatography using dichloromethane/methanol (20:1), to give Compound 33 as a solid (46.4 mg, 45.4%).

Compound 33 was identified and assayed, and the result was shown as follows: ¹H NMR (CdCl₃/pyridine-d₅, 400 MHz) δ_{H}=9.78 (d, J=4.8 Hz, 2H), 9.17 (d, J=4.4 Hz, 2H), 8.91 (d, J=4.4 Hz, 2H), 8.73 (d, J=4.4 Hz, 2H), 8.56 (s, 1H), 8.52 (s, 1H), 8.27 (dd, J=1.6 Hz, 1H), 8.11 (s, 1H), 8.03 (d, J=8.8 Hz, 1H), 7.96 (d, J=1.6 Hz, 4H), 7.73 (t, J=1.6 Hz, 2H), 7.16 (d, J=8.8 Hz, 4H), 6.91 (d, J=8.8 Hz, 4H), 2.45 (t, J=8.0 Hz, 4H), 1.49 (s, 36H), 1.23 (m, 12H), 0.82 (t, J=6.4 Hz, 6H); ¹³C NMR (CdCl₃/pyridine-d₅, 100 MHz) δ 169.2, 152.2, 150.5, 150.2, 149.7, 148.3, 141.6, 135.2, 134.4, 132.8, 131.9, 130.7, 130.4, 130.0, 129.6, 128.9, 128.6, 127.6, 126.6, 124.0, 123.7, 123.0, 121.7, 120.5, 98.7, 95.8, 95.4, 53.2, 35.0, 34.8, 31.6, 31.5, 31.3, 28.9, 22.4, 13.9; UV-Vis (THF): λₘₐₓ/nm (ε, 10³M⁻¹ cm⁻¹)=448(210), 590(10), 651(34). MALDI-TOF-MS: m/z calcd for C₈₅H₉₁N₅O₂Zn 1279. found 1279 ([M]⁺).

### Example 8

### Synthesis of Porphyrin Compound 34

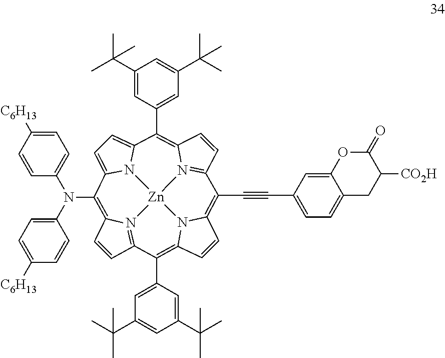

Compound 30 (0.16 mmol) and 7-iodo-2-oxo-2H-chromene-3-carboxylic acid (0.8 mmol) were dissolved in THF (45 mL) and Et₃N (8 mL); and the solution was deoxidized with nitrogen for 10 minutes. To the deoxidized solution was added Pd₂(dba)₃ (44 mg, 0.048 mmol) and AsPPh₃ (0.32 mmol); and the solution was refluxed for 4 hours under heating to perform the reaction. The reaction was cooled to room temperature. The solvent was removed under concentration to obtain a residue. The residue was purified by Silica Gel Column Chromatography using dichloromethane/methanol (20:1), to give Compound 34 as a solid (140.4 mg, 67.6%).

Compound 34 was identified and assayed, and the result was shown as follows: ¹H NMR (CdCl₃/pyridine-d₅, 400 MHz): δ 9.65 (d, J=4.8 Hz, 2H), 9.17 (d, J=4.8 Hz, 2H), 8.91 (d, J=4.8 Hz, 2H), 8.86 (s, 1H), 8.71 (d, J=4.8 Hz, 2H), 7.97 (t, J=2.4 Hz, 4H), 7.95 (d, J=2.0 Hz, 4H), 7.81 (d, J=8.4 Hz, 1H), 7.74 (s, 2H), 7.15 (d, J=8.4 Hz, 4H), 6.92 (d, J=8.8 Hz, 4H), 2.46 (t, J=7.2 Hz, 4H), 1.50 (s, 36H), 1.23 (m, 12H), 0.83 (t, J=6.4 Hz, 6H); ¹³C NMR (CdCl₃/pyridine-d₅, 100 MHz): δ 164.7, 159.8, 155.0, 152.2, 152.1, 150.4, 150.1, 149.9, 148.3, 141.3, 134.5, 133.2, 132.9, 131.0, 130.6, 129.7, 129.5, 128.6, 127.8, 124.6, 123.5, 121.8, 120.6, 118.3, 117.5, 117.1, 100.6, 96.7, 94.6, 35.0, 34.8, 31.5, 31.3, 28.8, 22.4, 13.9; UV-vis (THF): λₘₐₓ/nm (ε, 10³M⁻¹cm⁻¹)=453(125), 587(8), 663(41). MALDI-TOF-MS: m/z calcd for C₈₄H₈₉N₅O₄Zn 1295. found 1295 ([M]⁺).

### Example 9

### Synthesis of Porphyrin Compound 35

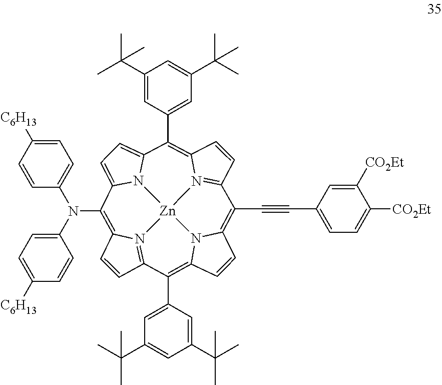

Compound 30 (0.08 mmol) and diethyl 4-iodoisophthalate (0.4 mmol) were dissolved in tetrahydrofuran (25 mL) and Et₃N (4 mL); and the solution was deoxidized with nitrogen for 10 minutes. To the deoxidized solution was added Pd₂(dba)₃ (0.024 mmol) and AsPPh₃ (0.16 mmol); and the solution was refluxed for 4 hours under heating to perform the reaction. The reaction was cooled to room temperature. The solvent was removed under concentration to obtain a residue. The residue was purified by Silica Gel Column Chromatography using ethyl acetate/n-hexane (1:4) and recrystallized from acetonitrile/ether, to give Compound 35 as a solid (93.7 mg, 88%).

Compound 35 was identified and assayed, and the result was shown as follows: ¹H NMR (CdCl₃, 400 MHz) δ_{H}=9.75 (d, J=4.4 Hz, 2H), 9.28 (d, J=4.4 Hz, 2H), 8.99 (d, J=4.8 Hz, 2H), 8.82 (d, J=4.8 Hz, 2H), 8.26 (d, J=1.6 Hz, 1H), 8.13 (dd, J=6.0 Hz, 1H), 8.03 (d, J=2.0 Hz, 4H), 7.90 (d, J=7.6 Hz, 1H), 7.79 (t, J=1.6 Hz, 2H), 7.22 (d, J=8.8 Hz, 4H), 6.98 (d, J=8.4 Hz, 4H), 4.47-4.35 (m, 4H), 2.49 (t, J=7.6 Hz, 4H), 1.53 (s, 36H), 1.45-1.38 (m, 6H), 1.30-1.24 (m, 12H), 0.85 (t, J=6.8 Hz, 6H).

### Example 10

### Synthesis of Porphyrin Compound 36

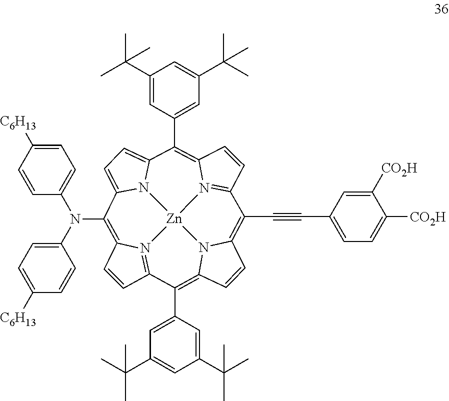

To Compound 35 (0.02 mmol) was added a mixture of NaOH (0.02 g), THF (5 mL) and water (1 mL). The solution was refluxed for 24 hours under heating, concentrated and filtered, to obtain a solid. The solid was dissolved in dichloromethane, acidified with an aqueous solution of glacial acetic acid, and then extracted once with water. The resulting solution was dried over anhydrous MgSO₄; and the solvents were removed under concentration, to give Compound 36 as a solid (28 mg, 99%).

Compound 36 was identified and assayed, and the result was shown as follows: ¹H NMR (CdCl₃/methanol-d₃, 400 MHz) δ 9.73 (d, J=4.8 Hz, 2H), 9.20 (d, J=4.8 Hz, 2H), 8.91 (d, J=4.4 Hz, 3H), 8.75 (d, J=4.4 Hz, 2H), 8.50 (d, J=8.0 Hz, 1H), 8.13 (d, J=9.2 Hz, 1H), 8.00 (s, 4H), 7.75 (s, 2H), 7.21 (d, J=8.4 Hz, 4H), 6.95 (d, J=8.4 Hz, 4H), 2.46 (t, J=7.6 Hz, 4H), 1.51 (s, 36H), 1.23 (m, 12H), 0.83 (t, J=6.4 Hz, 6H). MALDI-TOF-MS: m/z calcd for C₈₂H₈₉N₅O₄Zn 1271. found 1273 ([M+2H]⁺).

### Example 11

### Synthesis of Porphyrin Compound 37

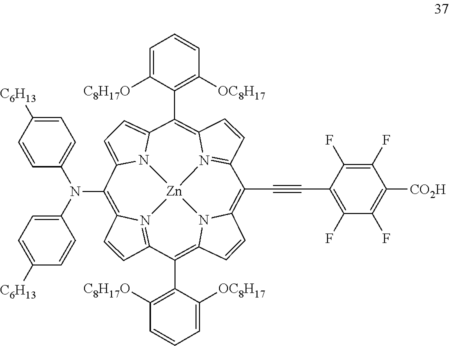

To a solution of Compound 22 (0.077 mmol) dissolved in tetrahydrofuran (10 mL) was charged TBAF (1M in THF, 0.39 mL), and reacted at room temperature for 30 minutes. The solvent was removed under concentration to obtain a residue. The residue was extracted with H₂O and dichloromethane. The extracts in the organic layer were combined and dried over anhydrous MgSO₄; and the solvent was removed under concentration, to give an intermediate product (105 mg, 99%) for being employed in the next reaction directly.

A solution of the intermediate product and 2,3,5,6-tetrafluoro-4-iodo-benzoic acid (123.0 mg, 0.38 mmol) dissolved in tetrahydrofuran (18 mL) and Et₃N (3.5 mL) was deoxidized with nitrogen for 10 minutes. To the deoxidized solution was added Pd₂(dba)₃ (0.023 mmol) and AsPPh₃ (0.15 mmol); and the solution was refluxed for 24 hours under heating to perform the reaction. The reaction was cooled to room temperature. The solvent was removed under concentration to obtain a residue. The residue was purified by Silica Gel Column Chromatography using dichloromethane/methanol (20:1), to give Compound 37 as a solid (24.5 mg, 20%).

Compound 37 was identified and assayed, and the result was shown as follows: ¹H NMR (CdCl₃/pyridine-d₅, 400 MHz) δ_{H}=9.70 (d, J=4.8 Hz, 2H), 9.17 (d, J=4.4 Hz, 2H), 8.88 (d, J=4.4 Hz, 2H), 8.68 (d, J=4.8 Hz, 2H), 7.66 (t, J=8.4 Hz, 2H), 7.20 (d, J=8.0 Hz, 4H), 6.96 (d, J=8.4 Hz, 8H), 3.82 (t, J=6.4 Hz, 8H), 2.44 (t, J=7.6 Hz, 4H), 1.56 (s, 4H), 1.24 (s, 12H), 0.97 (t, J=7.6 Hz, 16H), 0.83-0.81 (m, 14H), 0.62-0.49 (m, 36H). MALDI-TOF-MS: m/z calcd for C₉₇H₁₁₇F₄N₅O₆Zn 1589. found 1589 ([M]⁺).

### Example 12

### Synthesis of Porphyrin Compound 38

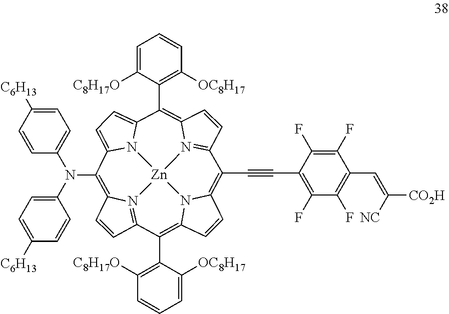

A mixture of 2-cyano-3-(2,3,5,6-tetrafluoro-4-iodo-phenyl)acrylic acid (141.0 mg, 0.38 mmol) added to Intermediate M prepared in the aforementioned Example 3 was dissolved in tetrahydrofuran (18 mL) and Et₃N (3.5 mL); and the mixture solution was deoxidized with nitrogen for 10 minutes. To the deoxidized solution was added Pd₂(dba)₃ (0.023 mmol) and AsPPh₃ (0.15 mmol). The solution was refluxed for 24 hours under heating to perform the reaction. The reaction was cooled to room temperature. The solvent was removed under concentration to obtain a residue. The residue was purified by Silica Gel Column Chromatography using dichloromethane/methanol (20:1), to give Compound 38 as a solid (85.9 mg, 68%).

Compound 38 was identified and assayed, and the result was shown as follows: ¹H NMR (CdCl₃/pyridine-d₅, 400 MHz) δ_{H}=9.62 (d, J=4.4 Hz, 2H), 9.16 (d, J=4.8 Hz, 2H), 8.91 (d, J=4.8 Hz, 2H), 8.66 (d, J=4.8 Hz, 2H), 7.87 (s, 1H), 7.68 (t, J=8.0 Hz, 2H), 7.21 (d, J=8.4 Hz, 4H), 6.99 (d, J=8.4 Hz, 4H), 6.95 (d, J=8.4 Hz, 4H), 3.87 (t, J=6.4 Hz, 8H), 2.47 (t, J=7.6 Hz, 4H), 1.52 (s, 4H), 1.25 (s, 12H), 1.03 (t, J=7.6 Hz, 16H), 0.85-0.79 (m, 14H), 0.66-0.45 (m, 36H); MALDI-TOF-MS: m/z calcd for C₁₀₀H₁₁₈F₄N₆O₆Zn 1640. found 1641 ([M+H]⁺).

### Example 13

### Synthesis of Porphyrin Compound 39

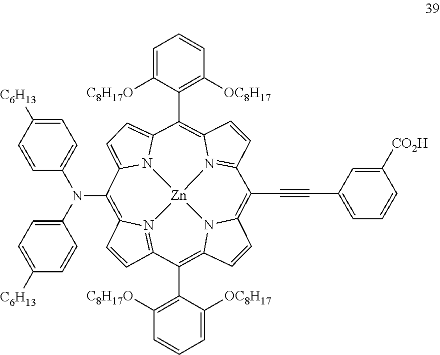

A mixture of 3-iodobenzoic acid (0.38 mmol) added to Intermediate M prepared in the aforementioned Example 3 was dissolved in tetrahydrofuran (18 mL) and Et₃N (3.5 mL); and the solution was deoxidized with nitrogen for 10 minutes. To the deoxidized solution was added Pd₂(dba)₃ (0.023 mmol) and AsPPh₃ (0.15 mmol). The solution was refluxed for 4 hours under heating to perform the reaction. The reaction was cooled to room temperature. The solvent was removed under concentration to obtain a residue. The residue was purified by Silica Gel Column Chromatography using dichloromethane/methanol (20:1), to give Compound 39 as a green solid (88 mg, 77%).

Compound 39 was identified and assayed, and the result was shown as follows: ¹H NMR (CdCl₃, 400 MHz) δ_{H}=9.67 (d, J=4.4 Hz, 2H), 9.17 (d, J=4.8 Hz, 2H), 8.87 (d, J=4.4 Hz, 2H), 8.68 (d, J=4.4 Hz, 3H), 8.19 (dd, J=9.2 Hz, 1H), 7.72 (s, 1H), 7.66 (t, J=8.4 Hz, 2H), 7.54 (d, J=8.4 Hz, 1H), 7.21 (d, J=8.4 Hz, 4H), 6.96 (d, J=8.4 Hz, 4H), 6.93 (d, J=8.8 Hz, 4H), 3.84 (t, J=6.4 Hz, 8H), 2.46 (t, J=7.6 Hz, 4H), 1.53 (s, 4H), 1.24 (s, 12H), 1.01 (t, J=7.6 Hz, 16H), 0.87-0.78 (m, 14H), 0.63-0.45 (m, 36H); ¹³C NMR (CdCl₃/pyridine-d₅, 100 MHz) δ_{c}=159.8, 151.8, 151.3, 150.3, 149.9, 134.6, 133.9, 132.5, 132.0, 131.5, 130.0, 129.2, 128.8, 128.3, 125.0, 122.3, 121.4, 113.6, 108.6, 105.1, 97.6, 94.7, 93.9, 68.4, 53.2, 35.1, 31.6, 31.3, 29.5, 29.0, 28.5, 25.0, 22.4, 22.2, 13.9, 13.7; UV-vis (THF): λₘₐₓ/nm (ε, 10³M⁻¹ cm⁻¹)=443(200), 580(14), 639(27). MALDI-TOF-MS: m/z calcd for C₉₇H₁₂₁N₅O₆Zn 1517. found 1518 ([M+H]⁺).

### Example 14

### Synthesis of Porphyrin Compound 40

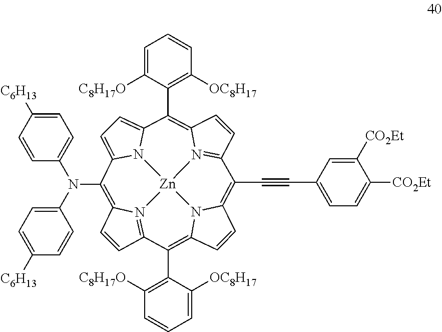

A mixture of diethyl 4-iodo-phthalate (112 mg, 0.32 mmol) added to Intermediate M prepared in the aforementioned Example 3 was dissolved in tetrahydrofuran (15 mL) and Et₃N (3.2 mL); and the solution was deoxidized with nitrogen for 10 minutes. To the deoxidized solution was added Pd₂(dba)₃ (17.7 mg, 0.019 mmol) and AsPPh₃ (40 mg, 0.13 mmol). The solution was refluxed for 4 hours under heating to perform the reaction. The reaction was cooled to room temperature; and the solvent was removed under concentration to obtain a residue. The residue was purified by Silica Gel Column Chromatography using ethyl acetate/n-hexane (1:4), to yield Compound 40 as a solid (77.7 mg, 75%).

Compound 40 was identified and assayed, and the result was shown as follows: ¹H NMR (CdCl₃, 400 MHz) δ_{H}=9.63 (d, J=4.4 Hz, 2H), 9.17 (d, J=4.4 Hz, 2H), 8.88 (d, J=5.2 Hz, 2H), 8.68 (d, J=4.4 Hz, 3H), 8.25 (d, J=1.2 Hz, 1H), 8.11 (dd, J=1.2 Hz, 1H), 7.96 (d, J=7.6 Hz, 1H), 7.67 (t, J=8.4 Hz, 2H), 7.21 (d, J=8.8 Hz, 4H), 6.96 (d, J=8.4 Hz, 4H), 6.93 (d, J=8.8 Hz, 4H), 4.51-4.41 (m, 4H), 3.84 (t, J=6.4 Hz, 8H), 2.47 (t, J=7.6 Hz, 4H), 1.48-1.42 (m, 6H), 1.30-1.25 (m, 16H), 0.99 (t, J=7.2 Hz, 16H), 0.89-0.76 (m, 14H), 0.65-0.43 (m, 36H).

### Example 15

### Synthesis of Porphyrin Compound 41

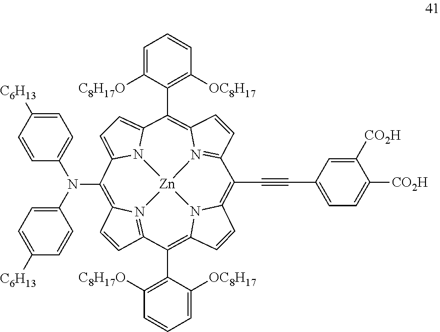

To Intermediate M (33.0 mg, 0.02 mmol) was added a mixture of NaOH (0.02 g), tetrahydrofuran (5 mL) and water (1 mL). The mixture solution was refluxed for 24 hours under heating, concentrated, and then filtered to obtain a solid. The solid was dissolved in dichloromethane, acidified with an aqueous solution of glacial acetic acid, and then extracted once with water. The extract was dried over anhydrous MgSO₄; and the solvents were removed under concentration, to give Compound 41 as a solid (30.2 mg, 95%).

Compound 41 was identified and assayed, and the result was shown as follows: ¹H NMR (CdCl₃/Methanol-d₃, 400 MHz) δ_{H}=9.58 (d, J=4.8 Hz, 2H), 9.06 (d, J=4.4 Hz, 2H), 8.83 (s, 1H), 8.75 (d, J=4.0 Hz, 2H), 8.56 (d, J=4.4 Hz, 2H), 8.43 (d, J=7.6 Hz, 1H), 8.08 (d, J=8.4 Hz, 1H), 7.64 (t, J=8.0 Hz, 2H), 7.17 (d, J=8.4 Hz, 4H), 6.94 (d, J=8.0 Hz, 4H), 6.88 (d, J=8.8 Hz, 4H), 3.81 (t, J=6.4 Hz, 8H), 2.42 (t, J=7.6 Hz, 4H), 1.47-1.43 (m, 6H), 1.30-1.19 (m, 16H), 0.95 (t, J=6.8 Hz, 16H), 0.89-0.78 (m, 14H), 0.72-0.48 (m, 36H).

### Example 16

### Synthesis of Porphyrin Compound 42

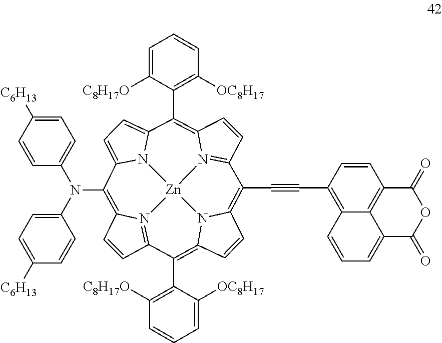

To a solution of Compound 22 (26.4 mg, 0.02 mmol) dissolved in tetrahydrofuran (5.0 mL) was added TBAF (1 M in THF, 0.08 mL, 0.08 mmol). After the solution was stirred at 25° C. for 30 minutes, the reaction was quenched with H₂O. Then, the solution was extracted with dichloromethane; and the extracts in the organic layer were combined and dried over anhydrous MgSO₄. The solvent was removed under concentration to obtain a residue. The residue was employed in the next reaction directly.

A mixture of 9-bromo-perylene-3,4-dicarboxylic anhydride (16.0 mg, 0.04 mmol) added to Pd₂(dba)₃ (2.2 mg, 2.5 mmol) and AsPh₃ (6 mg, 0.02 mmol) was dissolved in tetrahydrofuran (5 mL) and NEt₃ (1 mL); and the resulting solution was refluxed for 3 hours under heating to perform the reaction. The reaction was cooled to room temperature; and the solvents were removed under reduced pressure to obtain a residue. The residue was purified by Silica Gel Column Chromatography using dichloromethane/n-hexane (4:6) and recrystallized from dichloromethane/methanol, to give Compound 42 as a solid (55%).

Compound 42 was identified and assayed, and the result was shown as follows: ¹H NMR (CdCl₃, 400 MHz) δ_{H}=9.77 (d, J=4.4 Hz, 2H), 9.35 (d, J=8.4 Hz, 1H), 9.19 (d, J=4.4 Hz, 2H), 8.97 (d, J=4.4 Hz, 2H), 8.73 (d, J=8.4 Hz, 2H), 8.58 (br, 2H), 8.34 (d, J=5.6 Hz, 1H), 8.00 (s, 4H), 7.96 (t, J=8.0 Hz, 1H), 7.78 (s, 2H), 7.17 (d, J=8.4 Hz, 4H), 6.93 (d, J=8.4 Hz, 4H), 2.47 (t, J=8.0 Hz, 4H), 1.53 (s, 36H), 1.24 (m, 22H), 0.84 (m, 8H); ¹³C NMR (CdCl₃, 100 MHz) δ_{C}=158.9, 153.0, 152.1, 150.6, 150.4, 150.2149.0, 141.0, 135.1, 133.7, 132.8, 132.5, 131.4, 130.5, 129.6, 128.9, 128.6, 126.5, 125.8, 124.0, 122.5, 121.2, 117.6, 115.4, 108.7, 105.4, 97.7, 93.1, 35.2, 35.1, 31.7, 31.8, 31.5, 29.7, 29.5, 29.4, 29.2, 22.6, 14.1; UV-Vis (CH₂Cl₂): λₘₐₓ/nm (ε/10³ M⁻¹ cm⁻¹)=486(114), 679(38); IR (KBr, cm⁻¹): v=2957, 2923, 2854, 2174, 1768, 1719, 1587, 1506, 1451, 1340, 1250, 1018, 800, 711; HRMS: m/z calcd for C₉₀H₉₈N₅O₃Zn 1360.6956. found 1360.6982 ([M+H]⁺).

### Example 17

### Synthesis of Porphyrin Compound 47

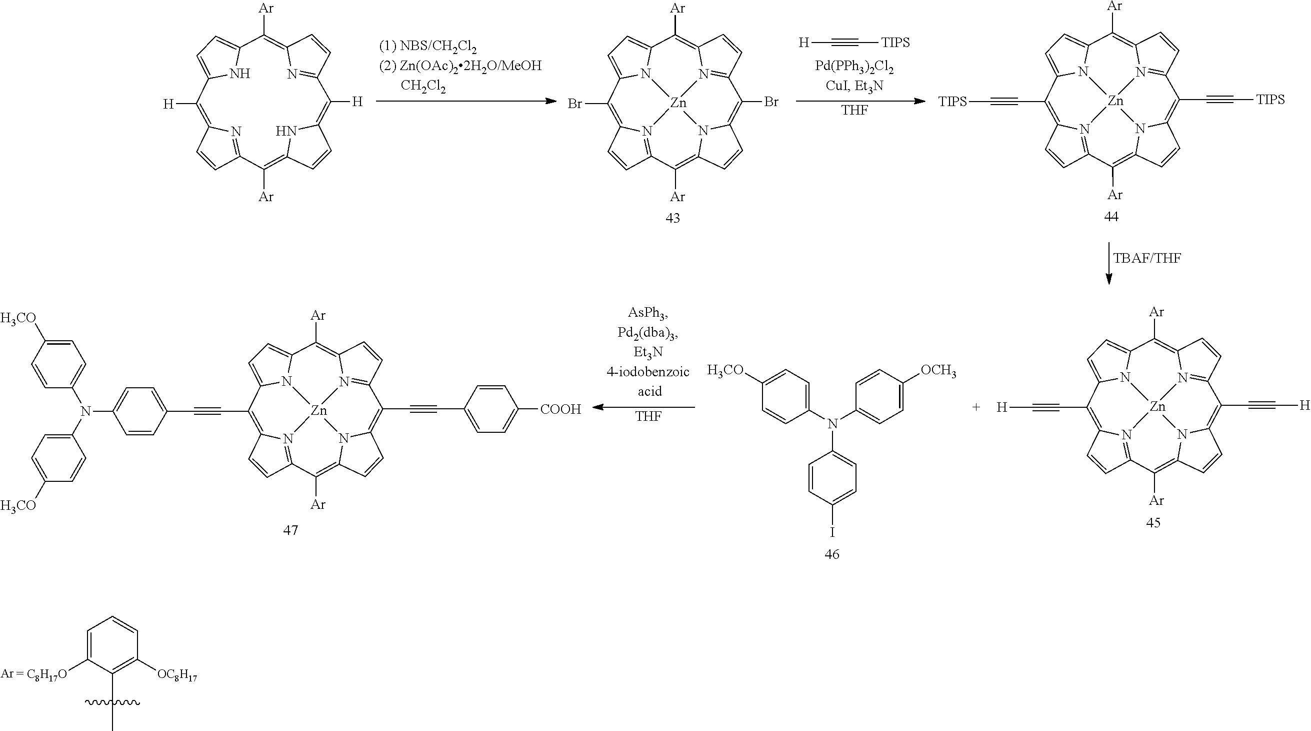

### i) Compound 43

A solution of Compound 18 added to dichloromethane (1500 mL) was stirred and deoxidized with nitrogen for 20 minutes. In an ice bath, a solution of N-bromosuccinimide NBS (2 mol) completely dissolved in dichloromethane (250 mL) was added dropwise to the solution of Compound 18 (975 mg, 1 mol), to perform the reaction. The reaction was traced by spotting the solution on TLC plate. After the reaction was quenched with acetone, the solvent was removed under concentration to obtain a residue. The residue was purified by Silica Gel Column Chromatography using dichloromethane/n-hexane (1:4), to give an intermediate product as a purple-red solid (980 mg, 82%). To a solution of the intermediate product dissolved in dichloromethane was added a solution of Zn(OAc)₂.2H₂O in MeOH; and the resulting solution was stirred and refluxed for 1 hour under heating. Then, the product solution was concentrated, shaken together with water for 10 minutes and filtered, to give Compound 43 as a purple-red solid.

Compound 43 was identified and assayed, and the result was shown as follows: ¹H NMR (400 MHz, cdcl₃) δ 9.52 (d, J=4.7 Hz, 4H), 8.81 (d, J=4.5 Hz, 4H), 7.71 (t, J=8.4 Hz, 2H), 7.00 (d, J=8.5 Hz, 4H), 3.85 (t, J=6.4 Hz, 8H), 1.08-0.91 (m, 9H), 0.83 (dd, J=14.5, 7.2 Hz, 9H), 0.72-0.21 (m, 50H), −2.60 (s, 2H).

### ii) Compound 44

A solution of Compound 43 (3.3 g, 2.76 mmol) dissolved in tetrahydrofuran (110 mL) and Et₃N (33.0 mL) was deoxidized with nitrogen for 15 minutes. To the deoxidized solution was added Pd(PPh₃)₂Cl₂ (0.264 g, 0.376 mmol) and CuI(I) (0.08 g, 0.42 mmol), and then charged triisopropylsilyl acetylene (3.1 mL). The resulting solution was refluxed for 3.5 hours under heating to perform the reaction. The reaction was cooled to room temperature. The solvent was removed under concentration to obtain a residue. The residue was purified by Silica Gel Column Chromatography using dichloromethane/n-hexane (1:2) and recrystallized from dichloromethane/methanol, to give Compound 44 as a solid (1.8 g, 46%).

Compound 44 was identified and assayed, and the result was shown as follows: ¹H NMR (400 MHz, cdcl₃) δ 9.68 (d, J=4.5 Hz, 4H), 8.88 (d, J=4.5 Hz, 4H), 7.69 (t, J=8.4 Hz, 2H), 7.01 (d, J=8.5 Hz, 4H), 3.85 (t, J=6.4 Hz, 8H), 1.57-1.37 (m, 42H), 1.03-0.90 (m, 9H), 0.83 (dd, J=14.6, 7.3 Hz, 11H), 0.67-0.32 (m, 49H).

iii) Compound 45

To a stirred solution of Compound 44 (1 g, 0.715 mmol) in THF (50 mL) was added TBAF (0.27 mL) at room temperature over 1 hour. The solution was concentrated, and then extracted with CH₂Cl₂. The extracts in the organic layer were combined and concentrated, to give Compound 45 as a solid (0.75 g, 97%). Compound 45 was employed directly in the next reaction.

### iv) Compound 46

To a mixture of 4-iodoanisole (0.70 g, 3.00 mmol), t-BuOK (0.34 g, 3.00 mmol), 2,2′-bipyridine (3 mg, 0.02 mmol) and CuI(I) (4 mg, 0.02 mmol) was added toluene (6 mL) and aniline (0.09 mL, 1.00 mmol). The solution was heated and reacted for 6 hours at 135° C. After the reaction was cooled to room temperature, the solid product was filtered off and washed with toluene. The filtrates were combined, and the solvent was removed therefrom to obtain a residue. The residue was purified by Silica Gel Column Chromatography using n-hexane, to give an intermediate product as a yellow solid (0.21 g, 70%).

The intermediate product was identified and assayed, and the result was shown as follows: ¹H NMR (400 MHz, CdCl₃) δ_{H}=7.15 (t, J=7.6 Hz, 2H), 7.03 (d, J=7.6 Hz, 4H), 6.91 (d, J=7.6 Hz, 2H), 6.72-6.88 (m, 5H), 3.77 (s, 12H).

Chloroform (10 mL) was added to a 25 mL three-necked flask charged with N,N-bis(4-methoxylphenyl)-N-phenylamine (200 mg, 0.66 mmol) and I₂ (200 mg, 0.80 mmol). After completely dissolving the solids, PhI₂(CF₃CO₂)₂ (172 mg, 0.40 mmol) was added. The reaction was maintained at 50° C. and performed for 1 hour. Subsequently, the reaction was cooled to room temperature, and the resulting product solution was washed with aqueous Na₂S₂O₃ solution and extracted with dichloromethane/water. The extracts in the organic layer were combined and dried over anhydrous MgSO₄, to obtain a residue. The residue was purified by Silica Gel Column Chromatography using dichloromethane/n-hexane (1:1) and recrystallized from ethanol/dichloromethane, to give Compound 46 as a pale-yellow solid (270 mg, 95%).

Compound 46 was identified and assayed, and the result was shown as follows: ¹H NMR (400 MHz, CdCl₃) δ_{H}=7.38 8.8 Hz, 2H), 7.01 (d, J=8.8 Hz, 4H), 6.80 (d, J=8.8 Hz, 4H), 6.65 (d, J=8.8 Hz, 2H), 3.77 (s, 12H).

### v) Compound 47

A mixture of Compound 45 (0.75 g, 0.7 mmol), 4-iodobenzoic acid (0.174 g, 0.7 mmol), Compound 46 (0.3 g, 0.7 mmol), Pd₂(dba)₃ (0.2 g, 0.21 mmol) and AsPh₃ (0.54 mg, 1.75 mmol) was dissolved in tetrahydrofuran (80 mL) and Et₃N (10 mL). The resulting solution was refluxed for 4.5 hours under heating. The solvent was removed under concentration to obtain a residue. The residue was purified by Silica Gel Column Chromatography using CH₂Cl₂/CH₃OH (9.5:1) and recrystallized from dichloromethane/methanol, to give Compound 47 as a solid (0.45 mg, 43%).

Compound 47 was identified and assayed, and the result was shown as follows: ¹H NMR (400 MHz, CdCl₃) δ 9.58 (t, J=4.2 Hz, 4H), 8.79 (d, J=4.5 Hz, 2H), 8.75 (d, J=4.5 Hz, 2H), 8.20 (d, J=8.4 Hz, 2H), 8.02 (d, J=8.3 Hz, 2H), 7.76 (d, J=8.6 Hz, 2H), 7.68 (t, J=8.4 Hz, 2H), 7.16 (d, J=8.9 Hz, 4H), 7.02 (dd, J=16.5, 8.6 Hz, 6H), 6.89 (d, J=8.9 Hz, 4H), 3.85 (d, J=6.5 Hz, 8H), 1.02-0.83 (m, 21H), 0.72 (dd, J=14.1, 8.0 Hz, 11H), 0.55 (t, J=7.3 Hz, 36H), 0.52-0.39 (m, 12H).

### Evaluation of Properties

### Test of Porphyrin Dyes

Reference Compound 48 represented by the following formula was provided as a control example. The photoelectric conversion efficiencies of Compound 9 (Example 1), Compound 23 (Example 3) and Compound 47 (Example 17) are measured under the test conditions as follows:

(1) Glass cell assembly: 1*1 cm²;

(2) Working electrode: FTO/TiO₂ (3T+AO+R)/TiCl₄, post-treated;

(3) Conditions of dye immersion: adsorption/immersion of dye solutions, 0.2 mM Compound 9, Compound 23, Compound 47/solvents (EtOH/toluene=1:1), at 40° C. for 4.5 hours;

(4) Counter electrode: FTO glass/self-synthesis 4-layered Pt/low-temperature silver wire;

(5) Conditions of electrolyte: 0.1M LiI, 0.05 M I₂, 0.5 M TBP, 0.6 M PMII in AN/VN=85/15; and

(6) Working area: 1 cm², thickness of surlyn film being 30 μm.

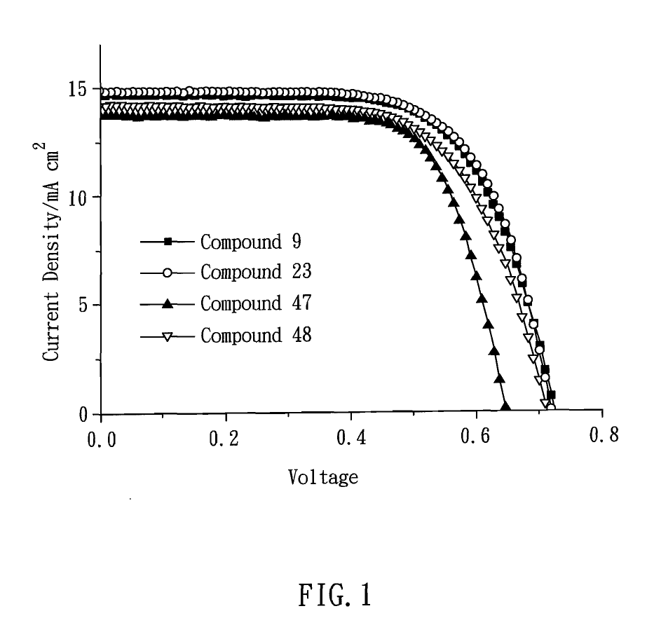

The test results are shown on Table 1 and FIG. 1.

TABLE 1

| | Voc^{a} | Isc^{b} | FF^{c} | η^{d} |
|---|---|---|---|---|
| Dyes | (V) | (mA) | (−) | (%) |
| Compound 9 | 0.720 | 14.720 | 0.67 | 7.100 |
| Compound 23 | 0.716 | 14.860 | 0.672 | 7.155 |
| Compound 47 | 0.618 | 12.498 | 0.623 | 4.811 |
| Compound 48^{e} | 0.71 | 14.149 | 0.656 | 6.593 |

^{a}Voc: Open Circuit Voltage, volt (V);
^{b}Isc: Short Circuit Current, milliamp (mA);
^{c}FF: Fill Factor;
^{d}η: Photoelectric conversion efficiency; and
^{e}Reference Compound 48 represented by the following formula:

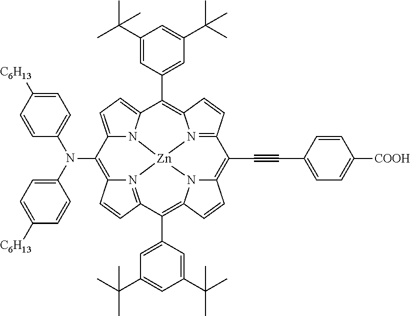

Referring to Table 1 and FIG. 1, the green zinc porphyrin-based photosensitive dyes obtained according to the present invention exhibit highly efficient push-pull performance, as compared with the control example of Compound 48. It appears that Compound 48 has a bulky tert-butyl group in its structure, which easily cause an aggregation of molecules and a reduction of photoelectric efficiency. In contrast to Compound 48, the zinc porphyrin-based photosensitive dyes of the present invention bears a tert-butyl group in structure, which is modified to form a long-chain alkoxy with hydrophobic group, thereby increasing the stereo hindrance and solubility of molecules and reducing the π-π interaction of the porphyrin ring itself. Accordingly, the aggregation of molecules can be avoided, and the injection efficiency of electrons into the surface of anode TiO₂ can be improved to reduce the charge recombination and to increase the photovoltaic property. For instance, the photoelectric conversion (η) of Compound 23 is 7.155%, which supports the fact that the stereo hindrance of molecules may be improved and the photoelectric conversion efficiency may be increased because of the reduction of aggregation of molecules.

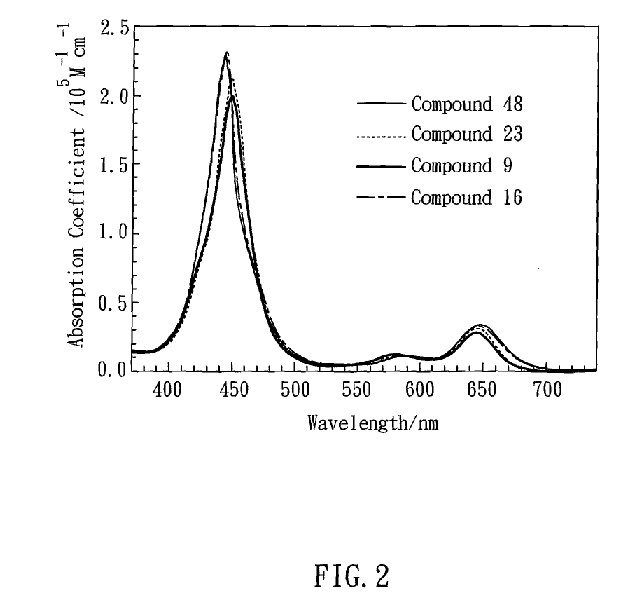

Also, The absorptions of the porphyrin dyes, such as Compound 9 (Example 1), Compound 16 (Example 2) and Compound 23 (Example 3) prepared according to the present invention, were determined by UV-Vis absorption spectrometry. The results are shown in FIG. 2. Referring to FIG. 2, the porphyrin compounds of the present invention exhibit the absorption within the ranges of 400 to 450 nm and 500 to 700 nm.

Those skilled in the art will recognize that the invention may be performed with variations on the disclosed compounds and processes without departing from the spirit or scope of the present invention as defined in the appended claims. The compounds described in the examples are intended to be representative of the present invention, and it is to be understood that the scope of the invention is not limited by the examples. All publications and patents cited above are incorporated herein by reference.

We claim:

1. A green zinc porphyrin-based photosensitive compound represented by a general formula (120) as follows: 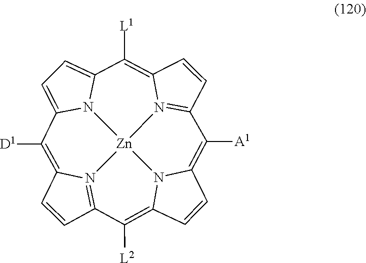
in the formula,
L¹ and L² are each independently phenyl or —NR^{a}R^{b}, in which phenyl is optionally substituted with one to five substituents selected from the group consisting of C₁₋₁₂ alkyl, C₁₋₁₂ alkoxy and phenyl; R^{a} and R^{b} are each independently selected from the group consisting of C₁₋₁₂ alkyl, C₁₋₁₂ alkoxy and phenyl, wherein phenyl is optionally substituted with one to five C₁₋₁₂ alkyl;
A¹ is selected from the group consisting of: 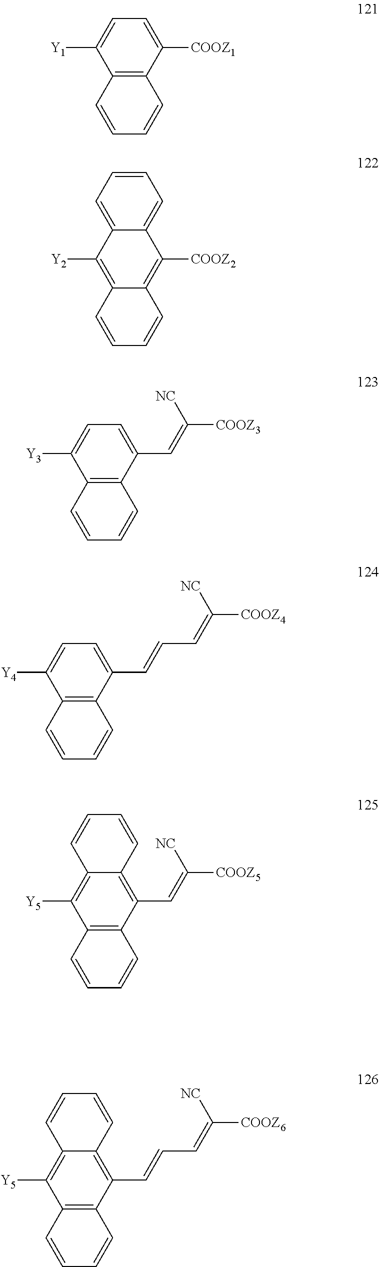 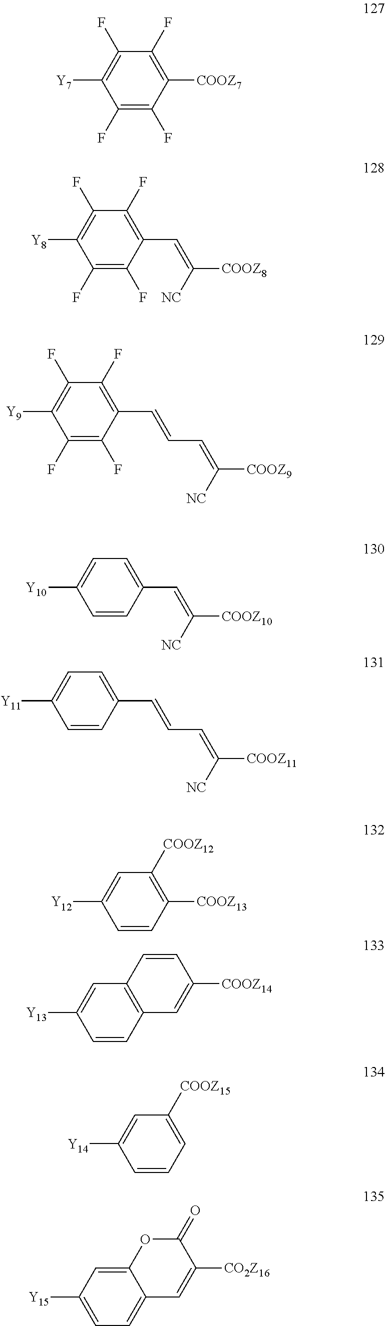 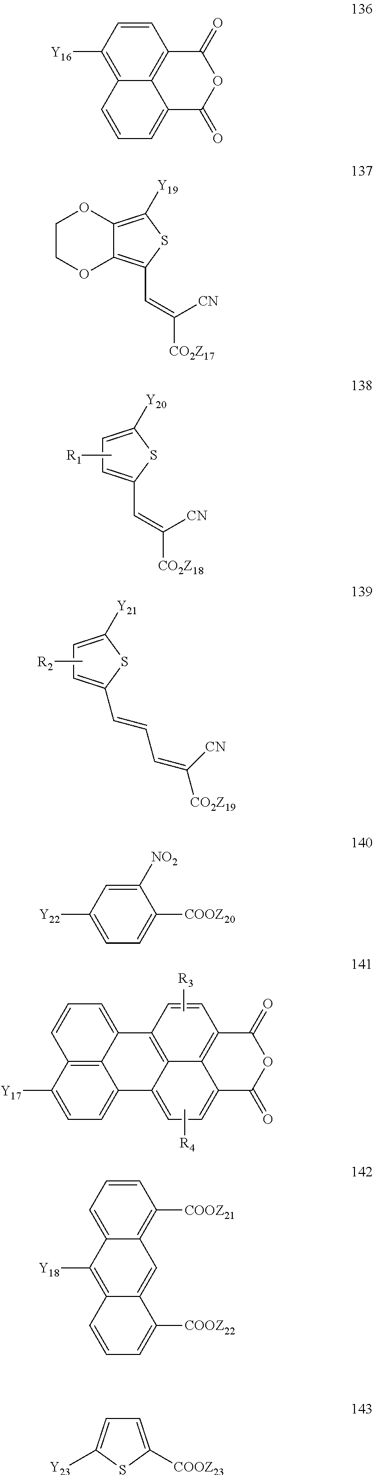
wherein R₁, R₂, R₃ and R₄ are each independently selected from the group consisting of H, C₁₋₁₂ alkyl, C₁₋₁₂ alkoxy, phenyl and phenoxy; Y₁˜Y₂₃ are each independently 0 to one C₁₋₁₀ alkyl, one to five C₂₋₁₀ alkenyl or one to five C₂₋₁₀ alkynyl; Z₁˜Z₂₃ are each independently H, alkali metals or quaternary ammonium represented by the following general formula (200): 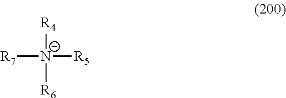
wherein R₄˜R₇ are each independently represented by CₘH₂ₘ₊₁ where m is an integer of 1 to 12; and
D¹ is selected from the group consisting of: 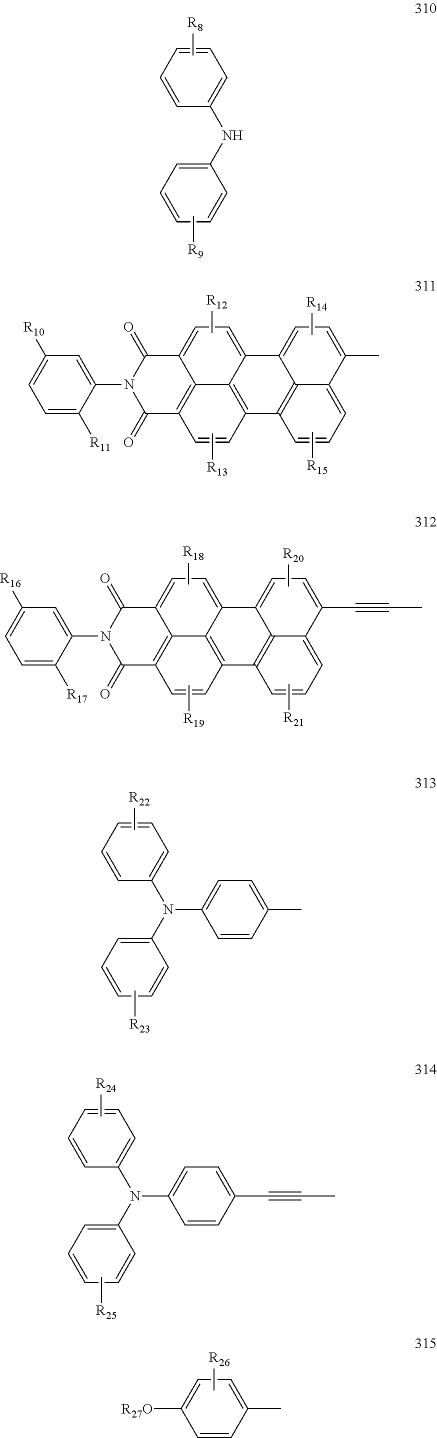 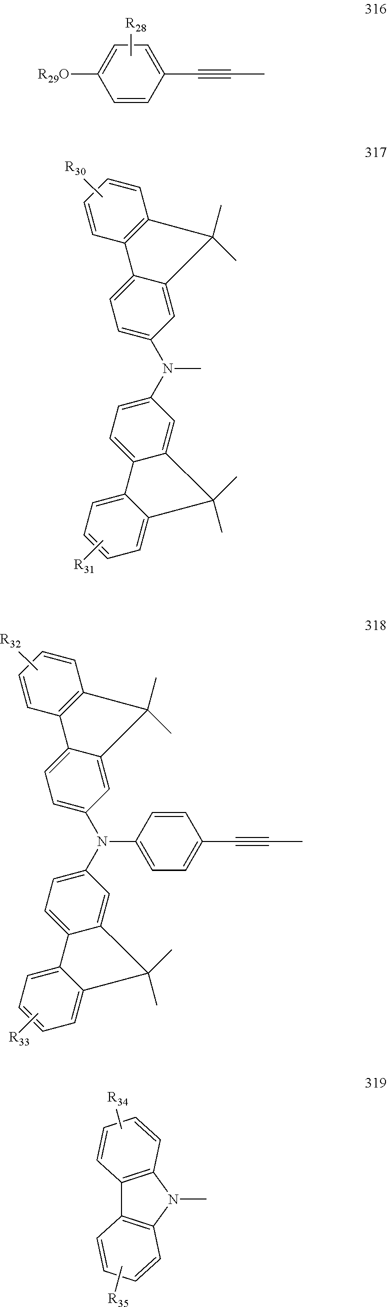 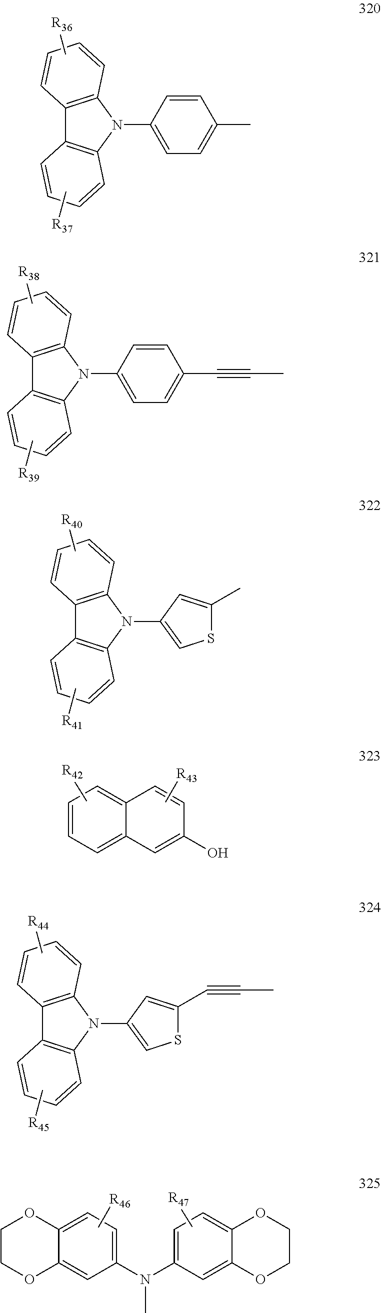 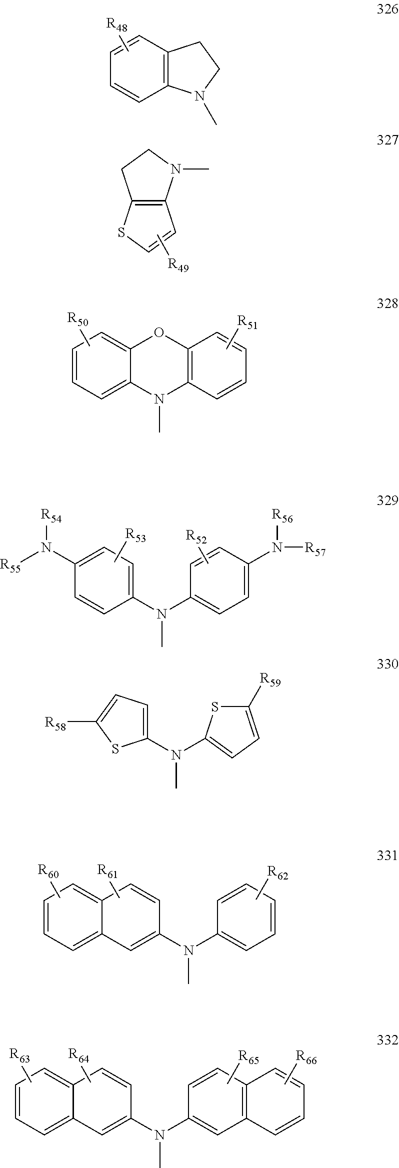
wherein R₈˜R₆₆ are each independently selected from the group consisting of H, phenyl, phenoxy, CₘH₂ₘ₊₁ where m is an integer of 1 to 12, OCₚH₂ₚ₊₁ where p is an integer of 1 to 12, CH₂(OC₂H₄)ₙOCH₃ where n is an integer of 1 to 30 and (OC₂H₄)_{q}OCH₃ where q is an integer of 1 to 30.

2. The zinc porphyrin-based photosensitive compound of claim 1, wherein L¹ and L² are each independently a phenyl substituted with two to five substituents selected from C₁₋₁₂ alkyl or C₁₋₁₂ alkoxy, with the proviso that at least one of substituent is C₁₋₁₂ alkoxy.

3. The zinc porphyrin-based photosensitive compound of claim 2, wherein L¹ and L² are each independently a phenyl having two to three substituents selected from C₁₋₁₂ alkyl or C₁₋₁₂ alkoxy.

4. The zinc porphyrin-based photosensitive compound of claim 3, wherein L¹ and L² are each independently a phenyl having two to three C₁₋₁₂ alkoxy.

5. The zinc porphyrin-based photosensitive compound of claim 1, wherein L¹ and L² are each independently —NR^{a}R^{b}, in which R^{a} and Rb are each independently selected from the group consisting of C₁₋₁₂ alkyl, C₁₋₁₂ alkoxy and substituted phenyl.

6. The zinc porphyrin-based photosensitive compound of claim 5, wherein R^{a} and R^{b} are each independently a phenyl substituted with one to five substituents selected from the group consisting of C₁₋₁₂ alkyl and C₁₋₁₂ alkoxy.

7. The zinc porphyrin-based photosensitive compound of claim 6, wherein R^{a} and R^{b} are each independently a phenyl substituted with two to three C₁₋₁₂ alkyl.

8. The zinc porphyrin-based photosensitive compound of claim 7, wherein R^{a} and R^{b} represent identical groups.

9. The zinc porphyrin-based photosensitive compound of claim 1, wherein L¹ and L² represent identical groups to form zinc porphyrins with symmetric structure.

10. The zinc porphyrin-based photosensitive compound of claim 1, wherein R₁, R₂, and R₃ are each independently selected from the group consisting of C₁₋₁₂ alkyl, C₂₋₁₀ monoalkenyl, C₂₋₁₀ dialkenyl, phenyl, phenyl substituted with C₁₋₆ alkyl, phenyl substituted with C₁₋₆ monoalkenyl, phenyl substituted with C₁₋₆ dialkenyl, phenyl substituted with C₂₋₆ alkynyl, naphthyl, anthranyl, and thienyl, in which C₂₋₁₀ monoalkenyl is optionally substituted with cyano, phenyl or naphthyl, where the phenyl or phenyl substituted with C₁₋₆ alkyl is optionally substituted with —NO₂ or halo.

11. The zinc porphyrin-based photosensitive compound of claim 1, wherein Z₁˜Z₂₃ are independently H or quaternary ammonium represented by the following general formula (200): 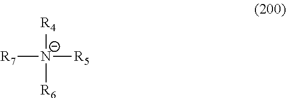
wherein R⁴, R⁵, R⁶, R⁷ are independently C₁₋₁₂ alkyl.

12. The zinc porphyrin-based photosensitive compound of claim 1, wherein the compound is selected from the group consisting of:

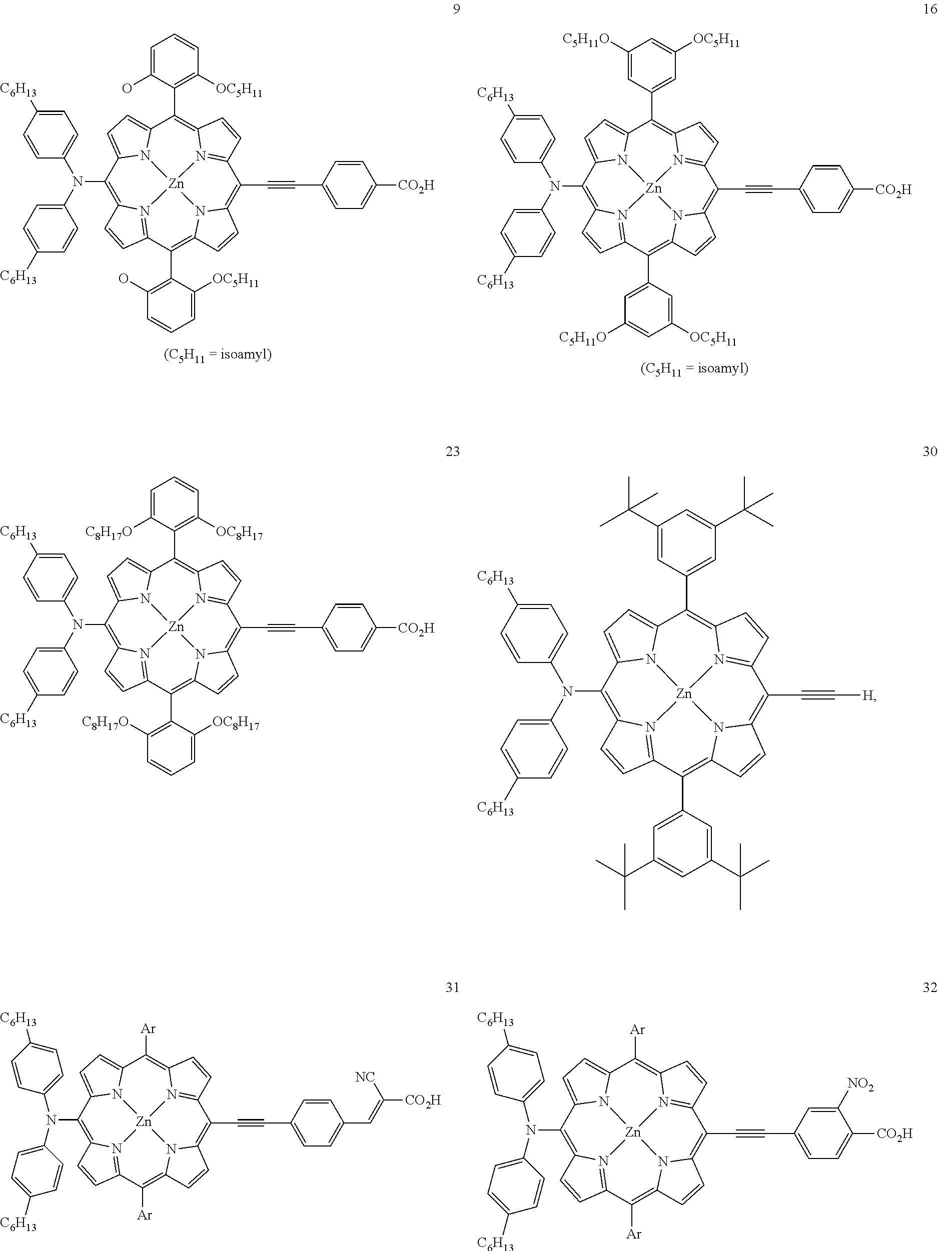

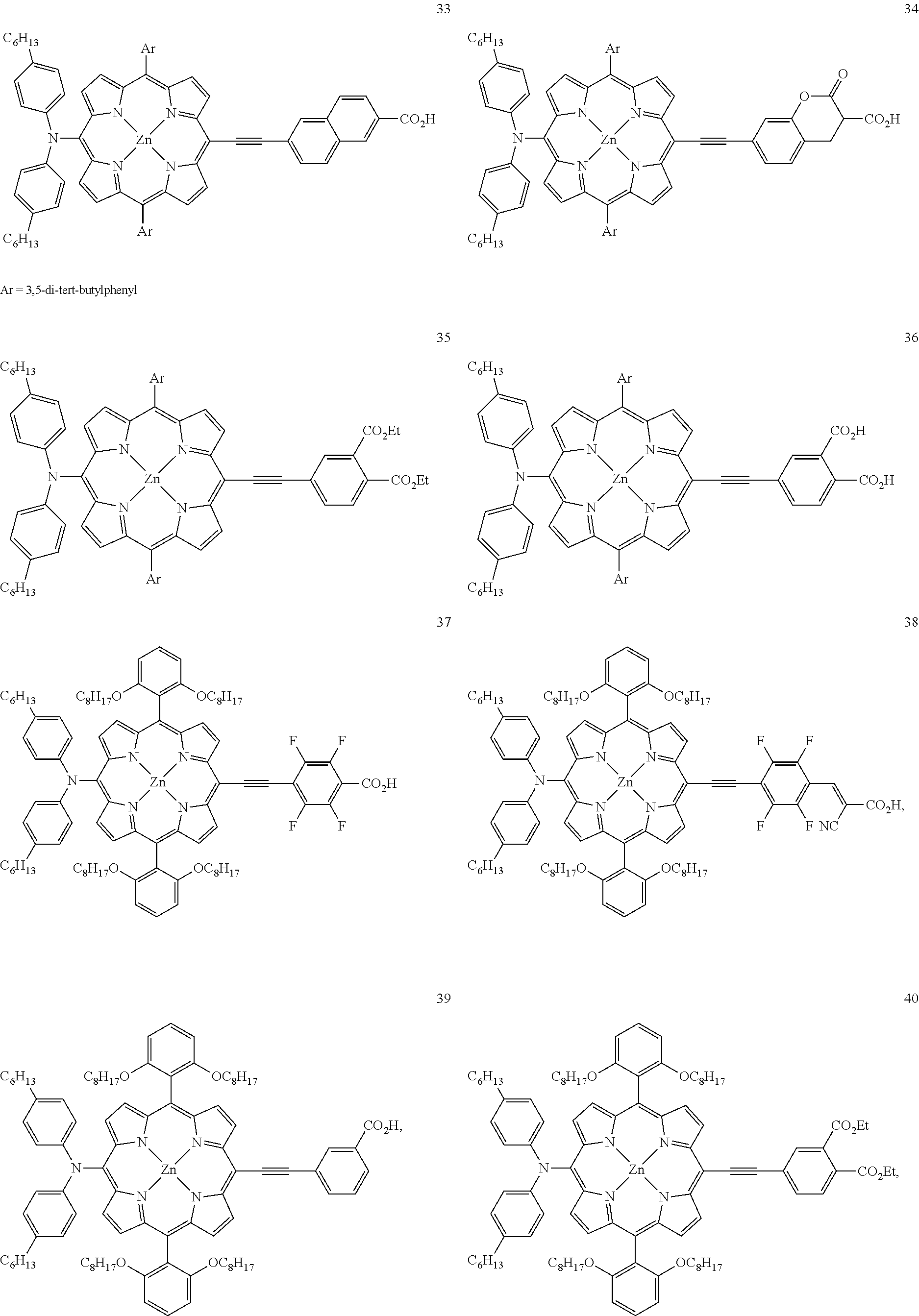

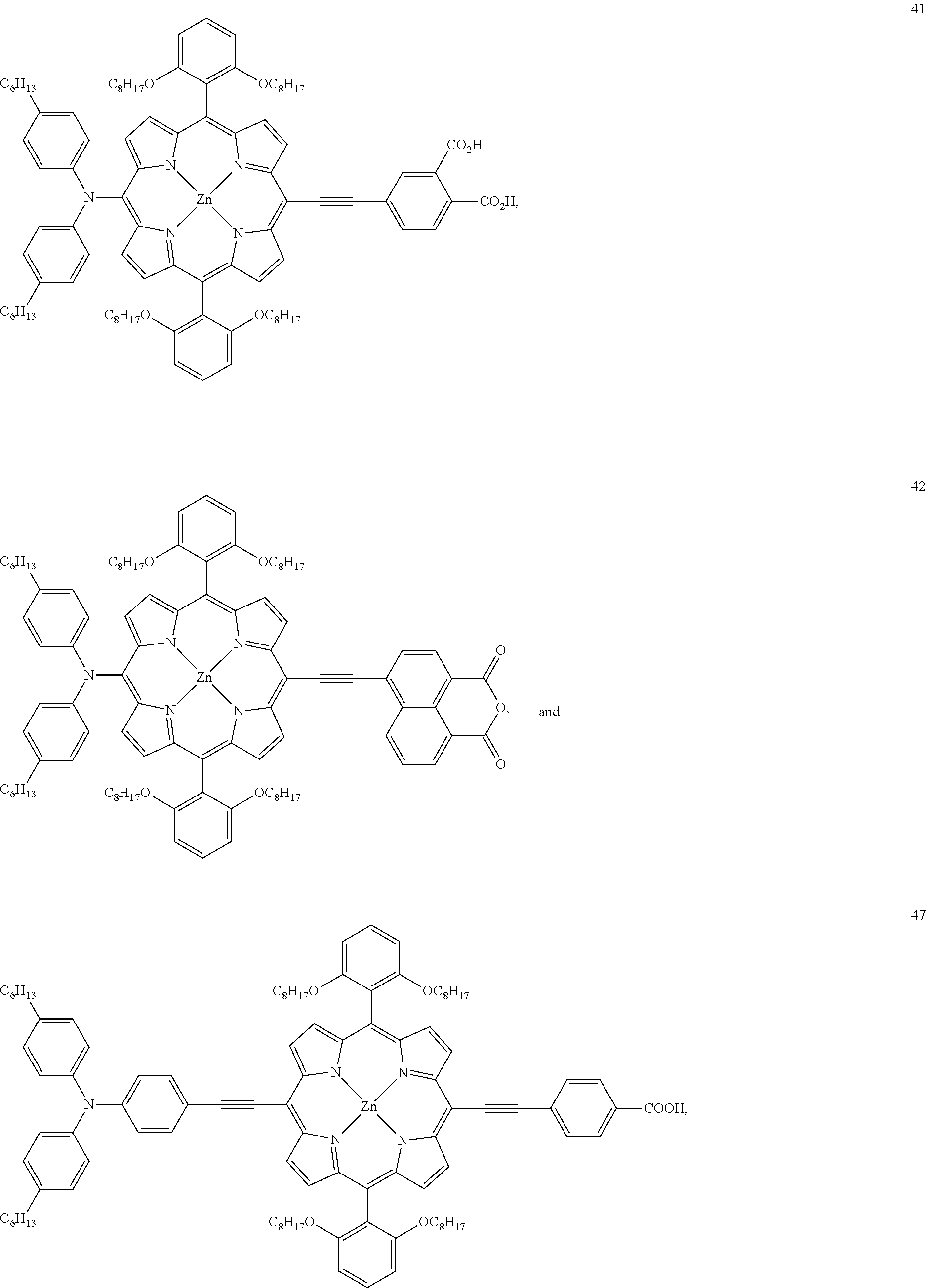

13. A photosensitized photoelectric device, characterized in that the device includes a zinc porphyrin-based photosensitive compound according to claim 1 used as a photosensitive dye for photoelectric conversion.

14. The photosensitized photoelectric device of claim 13, wherein the device is dye-sensitized solar cells.
